(19) United States
(12) Patent Application Publication
(10) Pub. No.: US 2026/0002427 A1
(43) Pub. Date: Jan. 1, 2026

(54) EMULATION OF RESERVOIR CONNECTIVITY MAPPING TO ESTIMATE WELL PRODUCTION PROFILES

(71) Applicant: Saudi Arabian Oil Company, Dhahran (SA)

(72) Inventors: Hisham Salem, Dhahran (SA); James Martin, Dhahran (SA); John Mbibi, Dhahran (SA)

(21) Appl. No.: 18/755,370

(22) Filed: Jun. 26, 2024

(51) Int. Cl. E21B 43/12; E21B 47/10; E21B 49/00; G01V 20/00

(52) U.S. Cl. CPC E21B 43/12; E21B 47/10; E21B 49/00; G01V 20/00; E21B 2200/20

(57) ABSTRACT

Systems, devices, and methods for prediction of well production profiles in hydrocarbon reservoirs. Spatial domain data and temporal domain data are received, from one or more probes. The spatial domain data characterizes rock properties within a subterranean volume including a hydrocarbon reservoir and the temporal domain data characterizes temporal variations of well productions. The spatial domain data is formatted as shell-formatted data including a shell format of concentric shells processable by prediction models. The shell-formatted data is provided as input for the prediction models to generate a plurality of well production profiles and hydrocarbon reservoir depletion profiles. The prediction models are trained using the temporal domain data. The hydrocarbon production from the hydrocarbon reservoir is managed based on the production profiles and the hydrocarbon reservoir depletion profiles.

### TECHNICAL FIELD

This disclosure relates to hydrocarbon reservoir management and, more specifically, to prediction of well production profiles in hydrocarbon reservoirs.

### BACKGROUND

Different types of predictions of well production profiles in hydrocarbon reservoirs are used for well planning and reservoir management. Some recent prediction types for well production include estimates of mapping of three-dimensional (3D) spatial reservoir connectivity. The 3D spatial reservoir connectivity can facilitate an identification of optimal drilling sites or “sweet reservoir spots”. Multiple sweet spots can also be targeted via suitable selection of well path and trajectory. The identification of sweet spots can include ranking of future drilling locations. Some existing techniques for sweet spot mapping and ranking using 3D reservoir models are based on static properties mapping that provide limited predictions of well production profiles. Other existing techniques for sweet spot mapping and ranking are based on computationally expensive simulation-based techniques.

### SUMMARY

Implementations of the present disclosure are directed to prediction of well production profiles in hydrocarbon reservoirs. More particularly, implementations of the present disclosure are directed to artificial intelligence (AI)-based emulation of reservoir connectivity mapping to estimate well production profiles in hydrocarbon reservoirs.

In some implementations, a method includes: receiving, from one or more probes, spatial domain data and temporal domain data, the spatial domain data characterizing rock properties within a subterranean volume including a hydrocarbon reservoir and the temporal domain data characterizing temporal variations of well productions, formatting the spatial domain data as shell-formatted data including a shell format processable by prediction models, the shell format including a series of concentric shells within a spatial volume at different depths around a well bore, providing the shell-formatted data as input for the prediction models to generate a plurality of well production profiles and hydrocarbon reservoir depletion profiles, the prediction models being trained using the temporal domain data, and managing hydrocarbon production from the hydrocarbon reservoir based on the production profiles and the hydrocarbon reservoir depletion profiles.

The foregoing and other implementations can each optionally include one or more of the following features, alone or in combination. In particular, implementations can include all the following features:

In a first aspect, combinable with any of the previous aspects, wherein the prediction models include a bi-directional long short-term memory model, a sequential model, and a bifurcated graph model. In another aspect, combinable with any of the previous aspects, the bi-directional long short-term memory model sequentially processes the shell-formatted data and patterns of the production profiles. In another aspect, combinable with any of the previous aspects, the sequential model includes two fully connected layers and weights that are adjusted to determine the patterns of the well production profiles, the weights being directly mappable to the spatial domain data. In another aspect, combinable with any of the previous aspects, the bifurcated graph model splits the shell-formatted data into two parallel streams and applies convolution to one of the two parallel streams to determine patterns in the well production profiles. In another aspect, combinable with any of the previous aspects, formatting the spatial domain data as shell-formatted data includes: performing data augmentation by generating synthetic data and adding the synthetic data to the spatial domain data to generate augmented data. In another aspect, combinable with any of the previous aspects, performing the data augmentation includes: shifting a first portion of the spatial domain data and rotating a second portion of the spatial domain data. In another aspect, combinable with any of the previous aspects, formatting the spatial domain data as shell-formatted data includes: applying standard linear interpolation to sample the spatial domain data for a set of spatial coordinates. In another aspect, combinable with any of the previous aspects, formatting the spatial domain data as shell-formatted data includes: labeling the shell-formatted data to generate labeled shell formatting data. In another aspect, combinable with any of the previous aspects, the rock properties include porosity, permeability, saturated hydrocarbon content, and clay content change. In another aspect, combinable with any of the previous aspects, the computer-implemented method further includes: generating a plot of the shell-formatted data that maps rock samples to areas of the plot, wherein points on the plot are plotted relative to an x-axis of effective porosity and a y-axis of total clay, and wherein a color or grayscale of a point is mapped to hydrocarbon volume scale, and presenting the plot in a graphical user interface.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Implementations described in the present disclosure, provide multiple technical advantages. For example, the prediction of well production profiles in hydrocarbon reservoirs described in the present disclosure is based on different prediction (e.g., AI) models, which perform a novel mapping of well production profiles in hydrocarbon reservoirs integrating spatial domain input data and time-domain production profile data, rather than disjointly spatial domain input data and time-domain production profile data, which can lead to significant errors in characterization of reservoirs and wells. Each model provides an estimate of the connectivity mapping process offering different computational and output type advantages. The described integration of the different prediction models facilitate extensibility to include more complex relationships between rock properties and the production profile. Another advantage of the described technology is that it provides the visualization of the network activations from the network perspective back to the three-dimensional (3D) domain. Furthermore, the described reservoir characteristic assessment approach allows a continuous training of prediction models that are integrated for the prediction of well production profiles in hydrocarbon reservoirs. Fine tuning of prediction models can maximize the validity of the predictions. Moreover, collaboratively training the machine learning models can facilitate direct optimization of well-trajectory in view of evolving changes to spatial domain input data and time-domain production profile data. Another advantage of the described technology is that the described reservoir characteristic assessment allows users (e.g., geo-mechanical managers, computing systems, or artificial intelligence systems) to optimize well production profile engine settings or to optimize other aspects of machine and device operations for continuation of operation of wells and optimization of reservoir management, which is particularly critical for complex and heterogeneous hydrocarbon reservoirs.

The details of one or more implementations of the subject matter of the specification are set forth in the accompanying drawings and the description below. Other features, aspects, and advantages of the subject matter can become apparent from the description, the drawings, and the claims.

### DESCRIPTION OF DRAWINGS

The accompanying drawings, which are incorporated in and constitute a part of this specification, show particular aspects of the subject matter disclosed herein and, together with the description, help explain some of the principles associated with the disclosed implementations. In the drawings:

FIG. 1A is a block diagram of an example system that can be used to execute implementations of the present disclosure;

FIG. 1B is a block diagram of a portion of the example system that can be used to execute implementations of the present disclosure;

FIG. 2A illustrates an example of spatial domain data, in accordance with some example implementations;

FIG. 2B illustrates another example of spatial domain data, in accordance with some example implementations;

FIG. 2C illustrates another example of spatial domain data, in accordance with some example implementations;

FIG. 3A illustrates an example of shell-formatted data, in accordance with some example implementations;

FIG. 3B illustrates another example of shell-formatted data, in accordance with some example implementations;

FIG. 3C illustrates another example of shell-formatted data, in accordance with some example implementations;

FIG. 4A illustrates an example of augmented data, in accordance with some example implementations;

FIG. 4B illustrates an example of labeled shell formatted data, in accordance with some example implementations;

FIG. 5A illustrates an example of a prediction model, in accordance with some example implementations;

FIG. 5B illustrates another example of a prediction model, in accordance with some example implementations;

FIG. 5C illustrates another example of a prediction model, in accordance with some example implementations;

FIG. 6A illustrates an example of a network activation, in accordance with some example implementations;

FIG. 6B illustrates another example of a network activation, in accordance with some example implementations;

FIG. 6C illustrates another example of a network activation, in accordance with some example implementations;

FIG. 7A illustrates an example production profile, in accordance with some example implementations;

FIG. 7B illustrates another example production profile, in accordance with some example implementations;

FIG. 8 depicts a flowchart illustrating an example process for prediction of well production profiles in hydrocarbon reservoirs, in accordance with some example implementations;

FIG. 9 depicts a block diagram illustrating a computing system, in accordance with some example implementations; and

FIG. 10 illustrates hydrocarbon production operations, in accordance with some example implementations.

When practical, like labels are used to refer to same or similar items in the drawings.

### DETAILED DESCRIPTION

Implementations of the present disclosure are directed to prediction of well production profiles in hydrocarbon reservoirs. More particularly, implementations of the present disclosure are directed to artificial intelligence (AI)-based emulation of reservoir connectivity mapping to estimate well production profiles in hydrocarbon reservoirs using spatial domain data and temporal domain data characterizing rock properties within a subterranean volume. The spatial domain data and temporal domain data can be collected by probes can be attached to or integrated in operating wells and observation wells within the industrial field, such as around a well bore. The spatial domain data is formatted as shell-formatted data according to a shell format processable by multiple prediction (e.g., AI) models that offer different advantages by approximating the connectivity mapping process. The prediction models can facilitate data extensibility to include more complex relationships between rock properties and the production profile. The prediction models can be trained using the temporal domain data and the trained prediction models can process the spatial domain data in near real-time (e.g., within milli-seconds or microseconds) to generate the well production profiles and hydrocarbon reservoir depletion profiles.

Addressing the challenges of three-dimensional (3D) reservoir models based on static property mapping that lack the impact of dynamic connectivity, the AI-based emulation of reservoir connectivity mapping described in the present disclosure enables accurate prediction of well production profiles and hydrocarbon reservoir depletion profiles. The AI-based emulation of reservoir connectivity mapping described in the present disclosure integrates complex relationships between rock properties and the production profile for determining temporal variations of well production profiles and hydrocarbon reservoir depletion profiles. The applied recurrent neural network activations are transparently presented to connect the recurrent neural network weights to the three-dimensional 3D spatial data and to improve interpretation of predicted well production profiles and hydrocarbon reservoir depletion profiles.

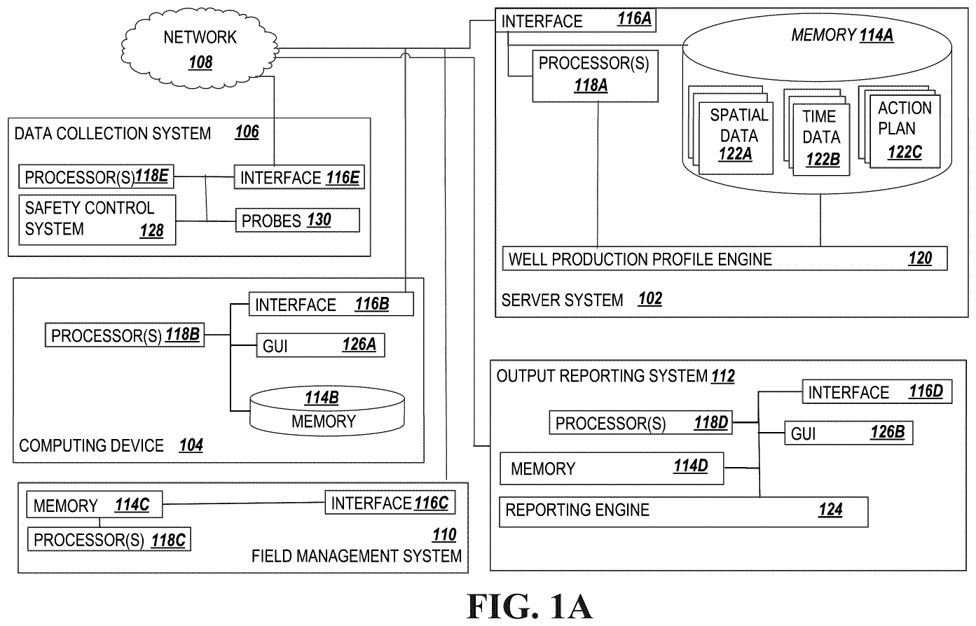

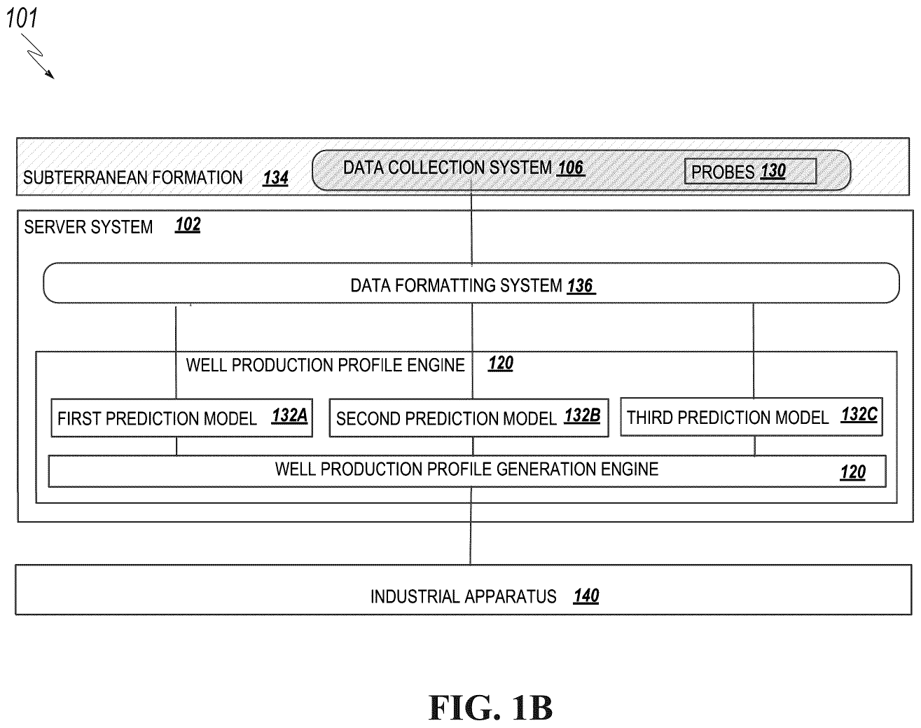

An advantage of the implementations described in the present disclosure is that it includes multiple prediction models, which automatically approximate the mapping of connected 3D grid cells and correlates patterns of inherent cells connectivity with production performance for a particular well, rather than analyzing limited spatial data with a singular prediction model, which can lead to significant errors in hydrocarbon well production profiles and hydrocarbon reservoir depletion profiles. Configurations of the prediction models can be adjusted, during training, using temporal domain data, to reflect particular field characteristics relative to a most current well state and hydrocarbon well path characterization. Another advantage of the described technology is that it provides key recommended actions for managing well production profiles to ensure optimization and continuity of well operations. Furthermore, the described hydrocarbon reservoir assessment approach allows a continuous training of machine learning models that are integrated in emulation of reservoir connectivity mapping to estimate well production profiles in hydrocarbon reservoirs. Fine tuning of machine learning models can maximize the accuracy of hydrocarbon reservoir characterization. Other advantages of the prediction of well production profiles in hydrocarbon reservoirs techniques are described with reference to FIGS. 1-10.

FIG. 1A illustrates an example system 100 that can be used to execute implementations of the present disclosure. Specifically, the illustrated example system 100 can be used to generate well production profiles and hydrocarbon reservoir depletion profiles and to manage hydrocarbon production from a hydrocarbon reservoir based on the production profiles and the hydrocarbon reservoir depletion profiles. The illustrated example system 100 includes or is communicably coupled with a server system 102, a computing device 104, a data collection system 106, a network 108, a field management system 110, and an output reporting system 112. Although shown separately, in some implementations, functionality of two or more systems or components of the example system 100 can be provided by a single system or server. In some implementations, the functionality of one illustrated system, server, or component can be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages prediction of well production profiles in hydrocarbon reservoirs within hydrocarbon fields for management of well operations using any number of components of the example system 100 including computing devices 104 (e.g., over the network 108). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes.

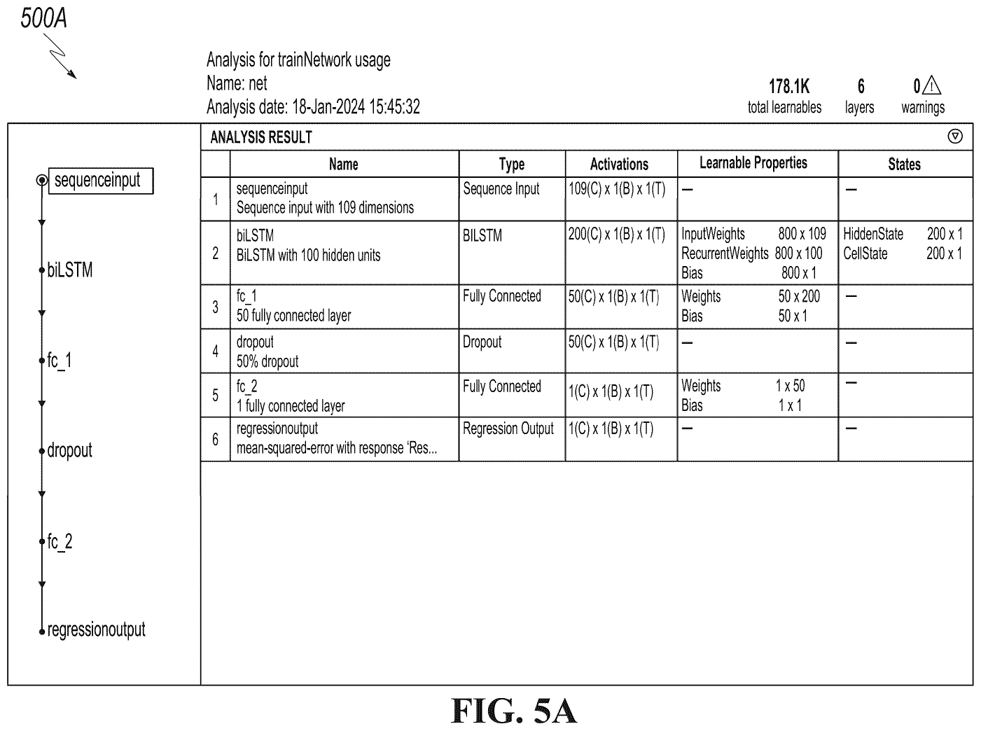

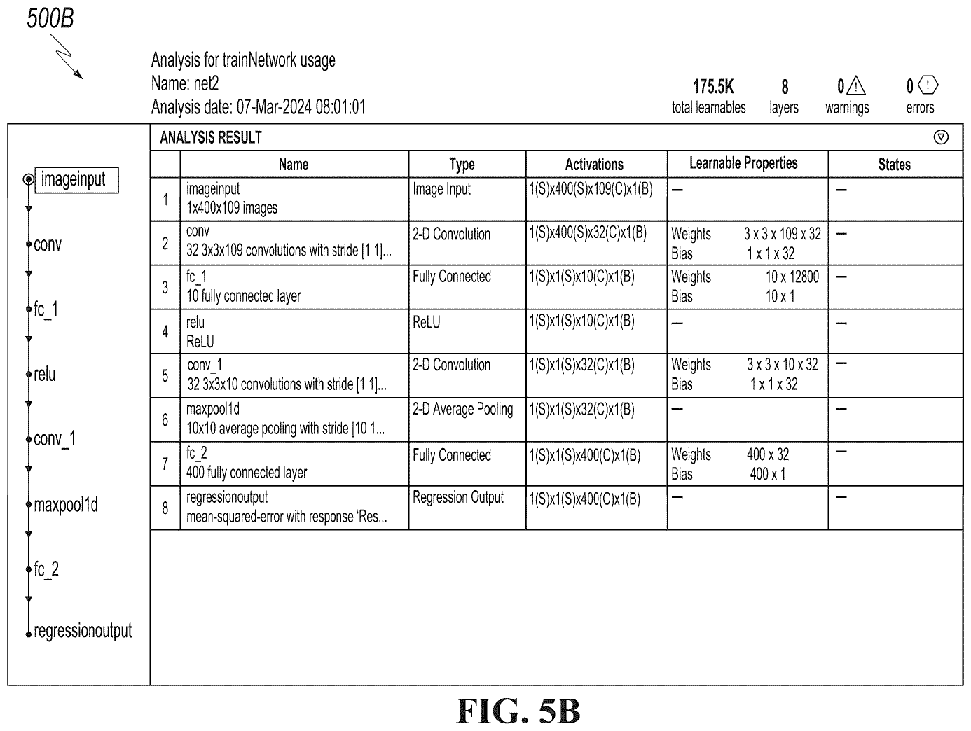

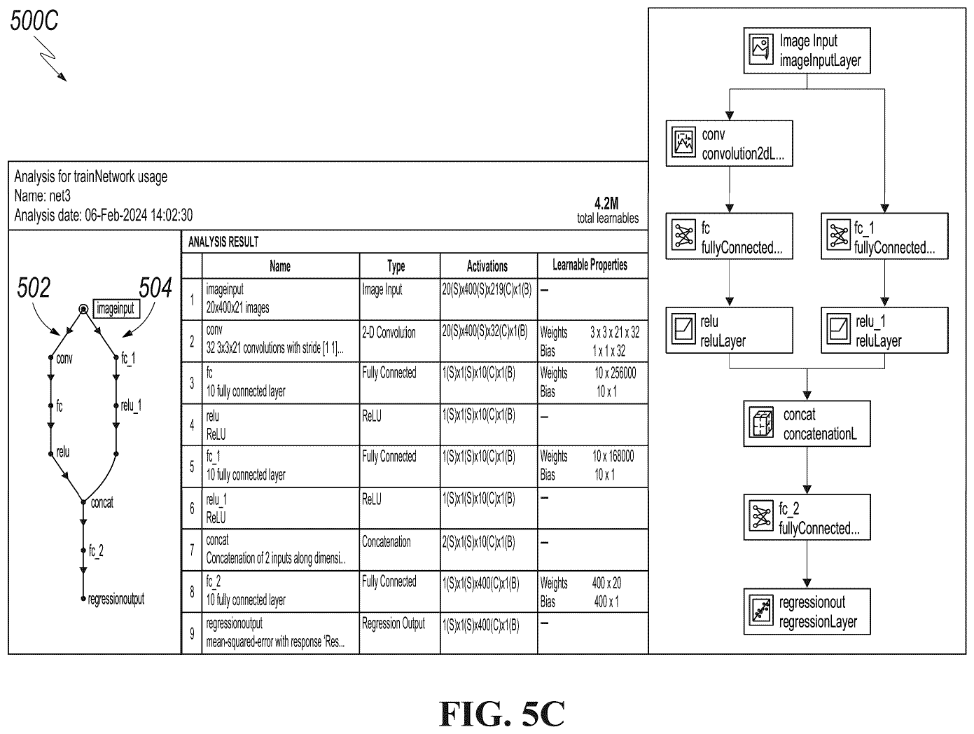

The server system 102 includes a memory 114A, an interface 116A, a processor 118A, and a well production profile engine 120. The memory 114A can store data (e.g., inputs and outputs of the well production profile engine 120), such as spatial domain data 122A, temporal domain data 122B, and action plans 122C. The spatial domain data 122A can include probe data can be received from the data collection system 106. The spatial domain data 122A can include live monitoring data, such as seismic data and pressure data. The temporal domain data 122B can include previously recorded time-domain series of production profile data, which can be analyzed, by the well production profile engine 120. In some implementations, an alert generation defined by the action plans 122C can also point to an internal security regulation set within the example system 100 (e.g., regulations adjusted to manage well vulnerabilities by the field management system 110). The action plans 122C in the memory 114A can include action plan documents defining threat prevention mechanisms including operations that can be performed by the components of the example system 100 to annihilate detected or estimated unsafe operations or to optimize well management based on well production profiles and hydrocarbon reservoir depletion profiles determined by the well production profile engine 120. The well production profile engine 120 can process spatial domain data 122A and temporal domain data 122B, obtained from the memory 114A, using prediction models (as described with reference to FIGS. 1B and 5A-5C) to analyze wells and hydrocarbon reservoirs within a field and to predict well production profiles and hydrocarbon reservoir depletion profiles in real time for generating output signals for the field management system 110 according to the action plans 122C.

The computing device 104, the field management system 110, and the output reporting system 112 can each be any computing device operable to connect to or communicate in the network(s) 108 using a wireline or wireless connection. In general, each of the computing device 104, the field management system 110, and the output reporting system 112 includes an electronic computer device operable to receive, transmit, process, and store any appropriate data associated with the example system 100 of FIG. 1A. Each of the computing device 104, the field management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the field management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including prediction of well production profiles in hydrocarbon reservoirs data (reports), and/or well operations, respectively. The GUIs 126A, 126B each interface with at least a portion of the example system 100 for any suitable purpose, including generating a visual representation of the data collected by the data collection system 106, data generated by the server system 102, or data stored by the server system 102, such as spatial domain data 122A, temporal domain data 122B, and action plans 122C, respectively. In particular, the GUIs 126A, 126B can each be used to view and adjust various hydrocarbon storage management operations. Generally, the GUIs 126A, 126B each provide the user with an efficient and user-friendly presentation of prediction of well production profiles in hydrocarbon reservoirs provided by or communicated within the example system 100. The GUIs 126A, 126B can each include multiple customizable frames or views having interactive fields, pull-down lists, and buttons operated by the user. The GUIs 126A, 126B can each be any suitable graphical user interface, such as a combination of a generic web browser, intelligent engine, and command line interface (CLI) that processes information and efficiently presents the results to the user visually.

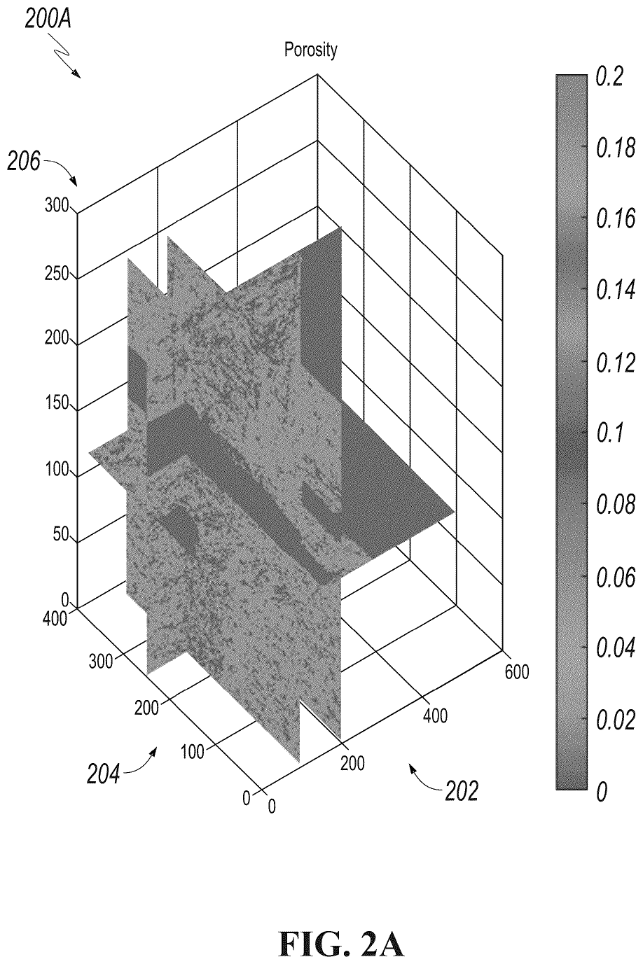

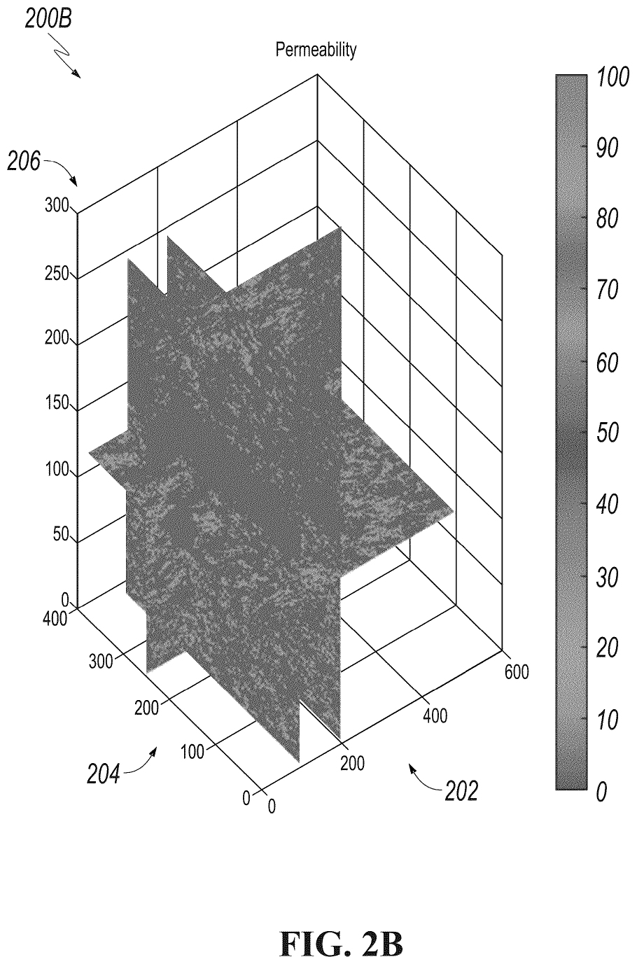

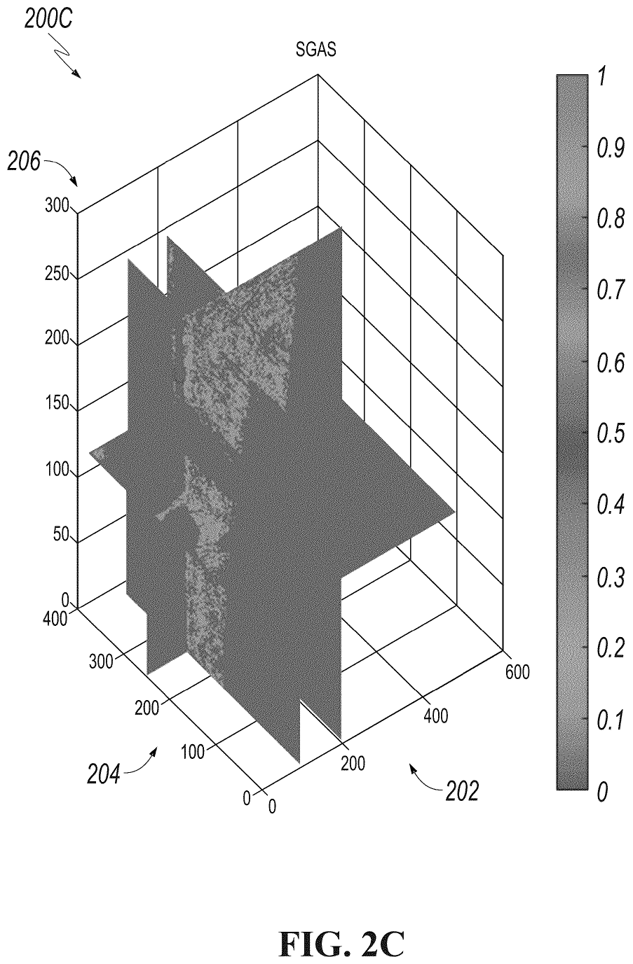

The output reporting system 112 can include a reporting engine 124, the GUI 126B (dashboard), a user module, and administrator modules. The reporting engine 124 utilizes the analytics data provided by the well production profile engine 120 to produce alerts to be displayed by the GUI 126B. The GUI 126B displays information related to the prediction of well production profiles in hydrocarbon reservoirs, as described with reference to FIGS. 2A and 2B. The GUI 126B display can enable well management by supporting modification of well operations.

The data collection system 106 can include a safety control system 128 and multiple probes 130. The safety control system 128 controls operation of the probes 130 and directs collected data to the server system 102 for storage, further analysis and correlations. The probes 130 can collect surface data and subterranean data within a field including one or more wells and one or more hydrocarbon reservoirs. The probes 130 can be coupled to or integrated in different types of components of the wells, to continuously monitor hydrocarbon storage, well production profiles, and hydrocarbon reservoir depletion profiles and secure the safety of the field operations. Further details about the probes 130 and their operation are provided with reference to FIG. 1B.

In some implementations, the network 108 can include a large computer network, such as a local area network, a wide area network, the Internet, a cellular network, a telephone network or an appropriate combination thereof connecting any number of communication devices, mobile computing devices, fixed computing devices and server systems. Data exchanged over the network 108, is transferred using any number of network layer protocols, such as internet protocol, multiprotocol label switching, asynchronous transfer mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit (CPU), an application specific integrated circuit (ASIC), a field-programmable gate array (FPGA), a Graphic Processing Unit (GPU), or another suitable component. Generally, each processor 118A, 118B, 118C, 118D, 118E executes instructions and manipulates data to perform prediction of well production profiles in hydrocarbon reservoirs within fields. For example, each processor 118A, 118B, 118C, 118D, 118E executes a functionality required to predict well production profiles and hydrocarbon reservoir depletion profiles in real time within fields, to plan well management, to execute well operations, and to maintain safety of field operations.

Interfaces 116A, 116B, 116C, 116D, 116E are used by different components of the example system 100 for communicating with other component systems in a distributed environment-including within the example system 100-connected to the network 108.

Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E can each include software supporting one or more communication protocols associated with communications such that the network 108 or interface's hardware is operable to communicate physical signals within and outside of the illustrated system 100.

The memory 1114A, 114B, 114C, 114D can include any type of memory or database module and can take the form of volatile and/or non-volatile memory including, without limitation, magnetic media, optical media, random access memory (RAM), read-only memory (ROM), removable media, or any other suitable local or remote memory component. The memory 1114A, 114B, 114C, 114D can store various objects or data, including caches, classes, frameworks, applications, backup data, business objects, jobs, web pages, web page templates, database tables, database queries, repositories storing safety data and/or dynamic information, and any other appropriate information including any parameters, variables, algorithms, instructions, rules, constraints, or references thereto associated with the purposes of the server system 102, the computing device 104, the data collection system 106, the field management system 110, and the output reporting system 112, respectively.

There can be any number of computing devices 104 and data collection systems 106 associated with, or external to, the example system 100. Additionally, there can also be one or more additional client devices external to the illustrated portion of system 100 that are capable of interacting with the example system 100 via the network(s) 108. Further, the term “client,” “client device,” and “user” can be used interchangeably as appropriate without departing from the scope of the disclosure. Moreover, while client devices can be described in terms of being used by a single user, the disclosure contemplates that many users can use one computer, or that one user can use multiple computers. As used in the present disclosure, the term “computer” is intended to encompass any suitable processing device. For example, although FIG. 1A illustrates a single server system 102, a single computing device 104, a single data collection system 106, a single field management system 110, the example system 100 can be implemented using a single, stand-alone computing device, two or more server systems 102, or multiple client devices. The server system 102, the computing device 104 and the output reporting system 112 can include any computer or processing device. According to one implementation, the server system 102 can also include or be communicably coupled with an e-mail server, a Web server, a caching server, a streaming data server, and/or another suitable server, as described with reference to FIG. 1B.

To further illustrate, FIG. 1B is a block diagram of a portion 101 of the example system 100 that can be used to execute implementations of the present disclosure. The example portion 101 of the example system 100 illustrated in FIG. 1B includes the server system 102 and the data collection system 106. The server system 102 includes the well production profile engine 120 that includes prediction models 132A, 132B, 132C. The well production profile engine 120 processes spatial domain data and temporal domain data collected by the data collection system 106 including the probes 130 distributed within a subterranean formation 134, such as around a well bore. The probes 130 can be used to measure rock properties including porosity, permeability, saturated gas content, and clay content change. The spatial domain data can include data associated with a 3D spatial distribution (e.g., depth and distance from the wellbore central longitudinal axis) such as image logs that can be used to build 3D rock property volumes. Alternative methods of building 3D spatial distributions could include suitably calibrated rock-property models, which are updated by recent seismic measurements or 4D seismic. Another method could include static property models, dynamic property models and dynamic property models which have been updated with recent production data.

The probes 130 can be static or mobile sensors recording data at a fixed location or multiple locations within the subterranean formation 134. The probes 130 can record data according to a set frequency and/or a schedule and can transmit the collected data in real time (within less than a second after data collection) to the server system 102 to be processed by the well production profile engine 120. The probes 130 can be wired or wirelessly connected to the network 108 to transmit the collected data to the server system 102. The probes 130 can be coupled to (e.g., integrated in) monitored systems (e.g., a wellhead, a machine, and/or an industrial apparatus) or can be separate measurement devices or imaging tools located at particular points of interest within the subterranean formation 134 that can correspond to one or more different areas within a geographical region around a wellbore. For example, one or more probes 130 can be installed near the wellbore to detect subterranean data (e.g., seismic data and/or pressure data) in the proximity of the wellbore. The probes 130 can be attached to a downhole tool that can be lowered into the wellbore to perform subterranean data measurements (e.g., fluid and/or formation measurements). In some examples, the probes 130 can be a single device that is transportable to measure surface and reservoir data for each formation of the subterranean region 134. The probe 130 can be located proximal to a hydrocarbon reservoir. The spatial domain data measured by the probes 130, within the subterranean formation 134 can have different petrophysical properties and 3D characteristics along various areas. For example, the area of the hydrocarbon reservoir that can be detectable beneath the surface by a first probe 130 can include a larger volume of hydrocarbons than an area of the reservoir that can be detectable beneath the surface by a second probe 130. By determining the spatial variation of rock properties through mapping a complete picture of the subterranean formation 134 within a local area, a prediction of well production profiles and hydrocarbon reservoir depletion profiles can be generated using the prediction models 132A, 132B, 132C.

In some examples, the well production profile engine 120 can process data collected by the probes 130 to format the data using the data formatting system 136 before sending the data to the prediction models 132A, 132B, 132C. For example, the data formatting system 136 can generate shell-formatted data including a shell format processable by prediction models. The shell format including a series of concentric shells within a spatial volume at different depths around a wellbore to maximize the accuracy of the predicted well production profiles and hydrocarbon reservoir depletion profiles.

The well production profile engine 120 can process data collected by the probes 130 using the prediction models 132A, 132B, 132C to evaluate shell-formatted spatial domain data and to forecast well production profiles and hydrocarbon reservoir depletion profiles. In some implementations, the prediction models 132A, 132B, 132C are based on AI prediction techniques related to a recurrent neural network (RNN), machine learning models, or a deep neural network. The RNN can be a bi-directional network that includes long/short-term memory (LSTM) units. RNN can advantageously provide flexibility of incorporating training data sequences of variable lengths. The LSTM units can be developed to deal with exploding and vanishing gradient problems that can be encountered when training traditional RNNs. The LSTM units may also be designed to learn long-term dependencies of temporal domain data, which can be useful for predicting well production profiles and hydrocarbon reservoir depletion profiles. For example, the LSTM units may allow the RNN to focus on more than just local features to classify the well production profiles and hydrocarbon reservoir depletion profiles. In some implementations, the RNN can be directional in nature, only utilizing information from the past. In some implementations, the first prediction model 132A can include a bi-directional LSTM network, as described with reference to FIG. 5A. The second prediction model 132A can include a sequential model, as described with reference to FIG. 5B. The third prediction model 132A can include a bifurcated graph model, as described with reference to FIG. 5C.

The described prediction models 132A, 132B, 132C utilize shell-formatted spatial data and temporal domain data for training. Shell-formatted spatial data is used for generating the prediction of the well production profiles and hydrocarbon reservoir depletion profiles. The described prediction models 132A, 132B, 132C can represent a relationship between static and dynamic geo-mechanical parameters to optimize prediction of well production profiles and hydrocarbon reservoir depletion profiles derived from the data collected by the probes 130. In one or more implementations, relationships between the received spatial domain data and the well production data can be determined during training of the prediction models 132A, 132B, 132C. The training step optimizes the weights and biases in the hidden and output layer such that the estimation error between the estimated well production profiles and observed well production profiles from the well log(s) can be minimized. Estimation error can be root mean square deviation, or a composite of root mean square deviation, cross-correlation, or a geoscience error metric. To avoid overfitting during training, regularization of the estimation error is performed based upon the norms of weights in the hidden layers that are added to the estimation error. An optimization process can include application of a stochastic gradient descent algorithm (or any other appropriate optimization algorithm), which can use one or more iterative optimization techniques and/or use a small subset of the training dataset or batch with training samples randomly selected at a time. The variances calculated based upon the horizontal and vertical semi-variograms are included in the input feature. The optimization process can optimize the weights and biases associated with the vertical and horizontal semi-variances, and other input features such that an error in the property estimates relative to the observed property values can be minimized. The process of training described here not only can minimize the error in well production profile estimates, but also can incorporate spatial variance of the geo-mechanical properties within the subterrancan formation 134. Following the completion of training that can be determined by the estimation error on the validation dataset falling below a cut-off value, the testing dataset can be used to determine the performance of the trained prediction models 132A, 132B, 132C on unseen well logs (e.g., not used for training). The trained prediction models 132A, 132B, 132C provide the ability of predicting the well production profiles and hydrocarbon reservoir depletion profiles at random 3D points in the region of interest based on the nearest neighbor points.

The trained prediction models 132A, 132B, 132C can determine a nonlinear relationship between input parameters (data collected by the probes 130) and model response by fitting a model to a training set of the available flow simulation runs, which is a subset of all runs (e.g., approximately 60%-80%). The trained prediction models 132A, 132B, 132C can be represented by a set of weights that are used to weigh nonlinear transform of input parameters as a weighted sum. The weighted sum represents an estimate of the output parameters from the flow simulation runs that are fitted to match recorded target output parameters as closely as possible. The remaining set of the flow simulation runs can be utilized for the testing and cross-validation of the trained prediction models 132A, 132B, 132C. Once the trained prediction models 132A, 132B, 132C is deemed to adequately describe relationship between estimated and measured well production profiles and hydrocarbon reservoir depletion profiles overtime, the trained prediction models 132A, 132B, 132C are used for prediction of well production profiles and hydrocarbon reservoir depletion profiles, given that the injection and re-production configurations do not change on the field 134 (e.g., the number of wells remains the same for subsequent time steps or the production operation stays the same for these wells in subsequent time steps).

Although only some examples of AI models were discussed for the purposes of explanation, it is appreciated that the prediction models 132A, 132B, 132C can include other trainable prediction techniques. Further, it is appreciated that other types of automated sequential sequence models, directed acyclic graph (DAG) models or neural networks can be utilized by the subject technology. For example, a convolutional neural network, regulatory feedback network, radial basis function network, modular neural network, instantaneously trained neural network, spiking neural network, regulatory feedback network, dynamic neural network, neuro-fuzzy network, compositional pattern-producing network, memory network, and/or any other appropriate type of neural network can be utilized.

FIG. 2A illustrates an example of spatial domain data 200A, in accordance with some example implementations. The example of spatial domain data 200A can be displayed by a graphical user interface (e.g., GUIs 126A, 126B, described with reference to FIG. 1A). The example of spatial domain data 200A, shown in FIG. 2A, can be used to train prediction models, and can be formatted to be processed by trained prediction models to predict well production profiles and hydrocarbon reservoir depletion profiles well parameters in real time. The example of spatial domain data 200A can include data obtained from a database (e.g., memory 114A, described with reference to FIG. 1A) and data (e.g., wellhead and downhole parameters) collected by the probes 130, described with reference to FIGS. 1A and 1B. The example of spatial domain data 200A, shown in FIG. 2A, can include porosity data (for example, in decimal units (v/v)) represented as a spatial distribution along an x-axis 202, a y-axis 204, and a z-axis 206.

FIG. 2B illustrates another example of spatial domain data 200B, in accordance with some example implementations. The example of spatial domain data 200B can be displayed by a graphical user interface (e.g., GUIs 126A, 126B, described with reference to FIG. 1A). The example of spatial domain data 200B, shown in FIG. 2B, can be used to train prediction models and can be formatted to be processed by trained prediction models to predict well production profiles and hydrocarbon reservoir depletion profiles well parameters in real time. The example of spatial domain data 200A can include data obtained from a database (e.g., memory 114A, described with reference to FIG. 1A) and data (e.g., wellhead and downhole parameters) collected by the probes 130, described with reference to FIGS. 1A and 1B. The example of spatial domain data 200B, shown in FIG. 2B, can include permeability data (for example expressed in Darcy, corresponding to cubic centimeter of fluid (having a viscosity of one centipoise) per second) represented as a spatial distribution along an x-axis 202, a y-axis 204, and a z-axis 206.

FIG. 2C illustrates another example of spatial domain data 200C, in accordance with some example implementations. The example of spatial domain data 200C can be displayed by a graphical user interface (e.g., GUIs 126A, 126B, described with reference to FIG. 1A). The example of spatial domain data 200C, shown in FIG. 2C, can be used to train prediction models and can be formatted to be processed by trained prediction models to predict well production profiles and hydrocarbon reservoir depletion profiles well parameters in real time. The example of spatial domain data 200C can include data obtained from a database (e.g., memory 114A, described with reference to FIG. 1A) and data (e.g., wellhead and downhole parameters) collected by the probes 130, described with reference to FIGS. 1A and 1B. The example of spatial domain data 200C, shown in FIG. 2C, can include saturated gas content data (for example expressed in percentage or decimals) represented as a spatial distribution along an x-axis 202, a y-axis 204, and a z-axis 206.

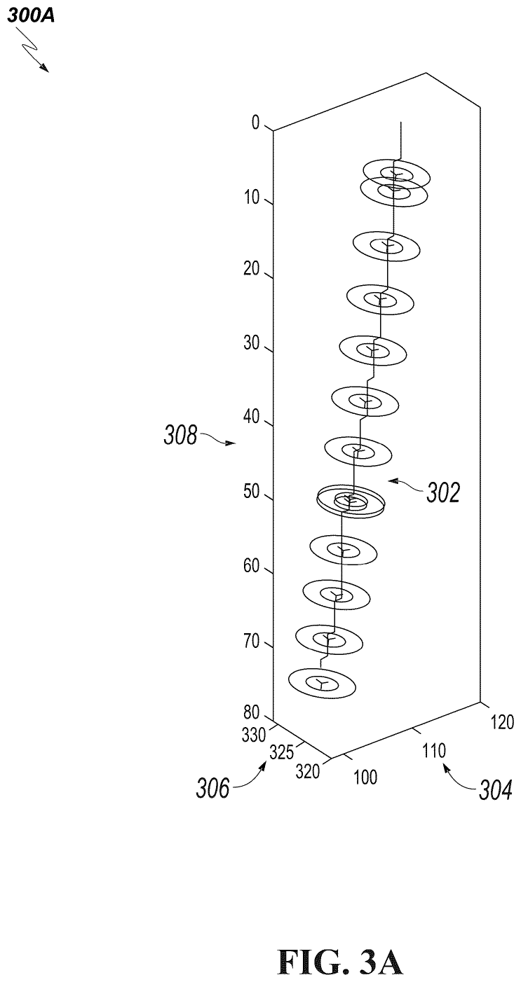

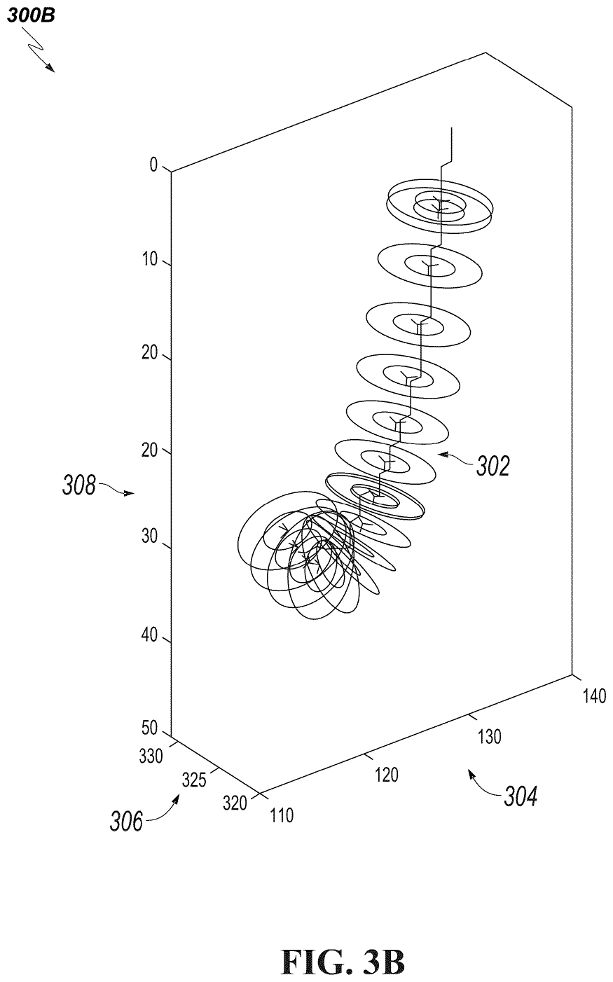

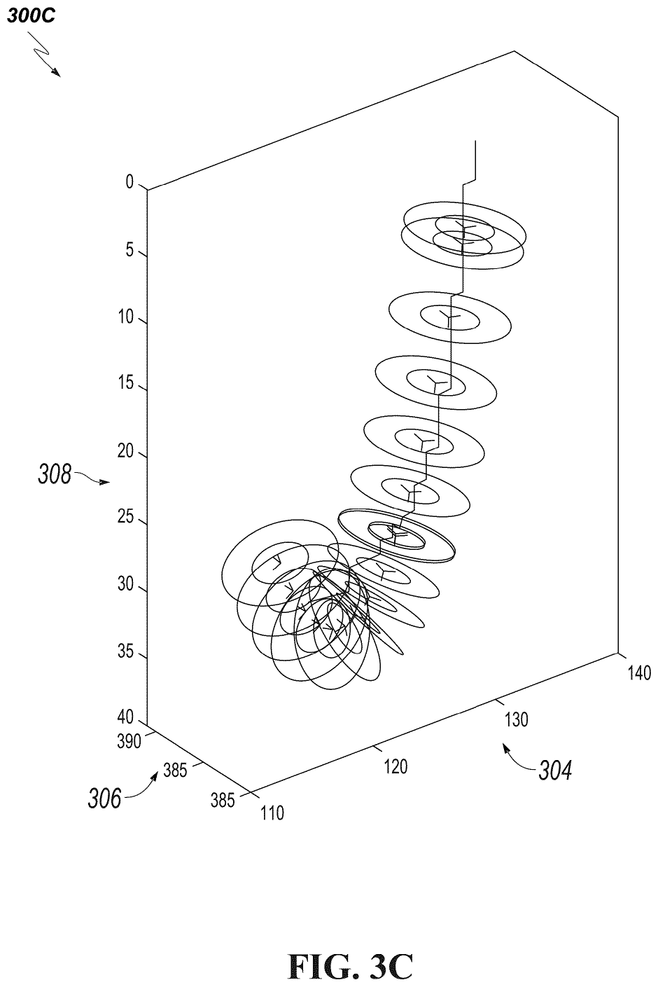

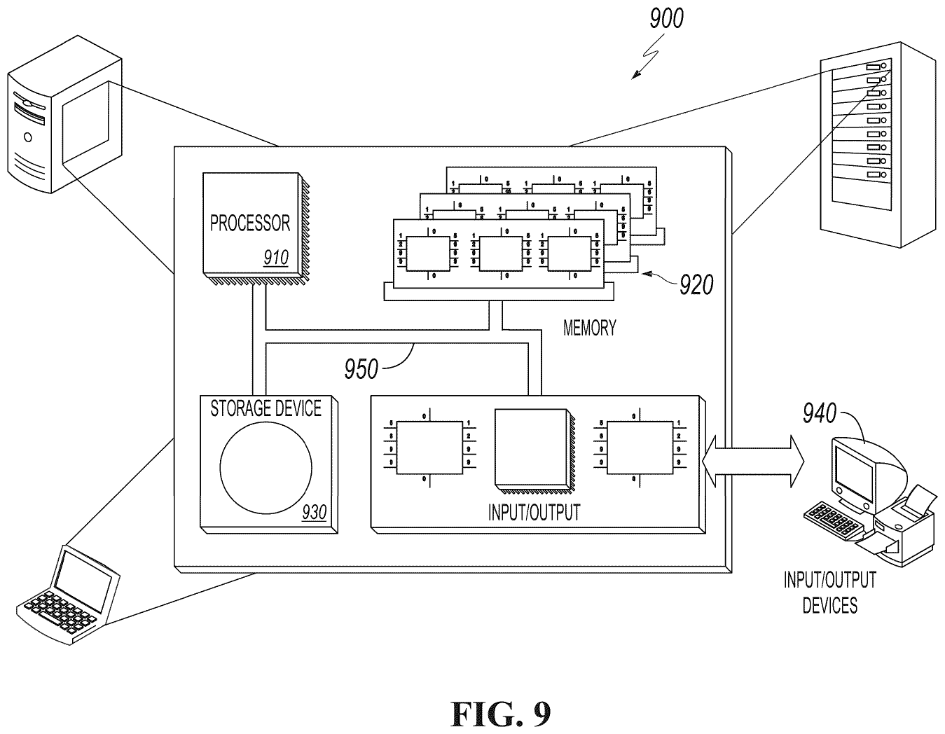

FIG. 3A illustrates an example of shell-formatted data 300A, in accordance with some example implementations. FIG. 3B illustrates another example of shell-formatted data 300B, in accordance with some example implementations. FIG. 3C illustrates another example of shell-formatted data 300C, in accordance with some example implementations. The example of shell-formatted data 300A, 300B, 300C can include outputs of an estimated production profile for a respective well path generated by a data formatting system (e.g., data formatting system 136, described with reference to FIG. 1B), as described with reference to FIG. 9. The example of shell-formatted data 300A, 300B, 300C can be displayed by a graphical user interface (e.g., GUIs 126A, 126B, described with reference to FIG. 1A). The example of shell-formatted data 300A, 300B, 300C, shown in FIGS. 3A-3C, can be used by trained prediction models to predict well production profiles and hydrocarbon reservoir depletion profiles well parameters in real time. The example of shell-formatted data 300A, 300B, 300C can include formatted data generated by a data formatting system (e.g., data formatting system 136, described with reference to FIG. 1B). The example shell-formatted data 300A, 300B, 300C can include rock properties along the well path formatted in a set of concentric cylinder “shells” around the wellbore, which ensures enough information is present which correlates to rates of change along the well path 302. The example shell-formatted data 300A, 300B, 300C can be represented as a spatial distribution along an x-axis 304, a y-axis 306, and a z-axis 308.

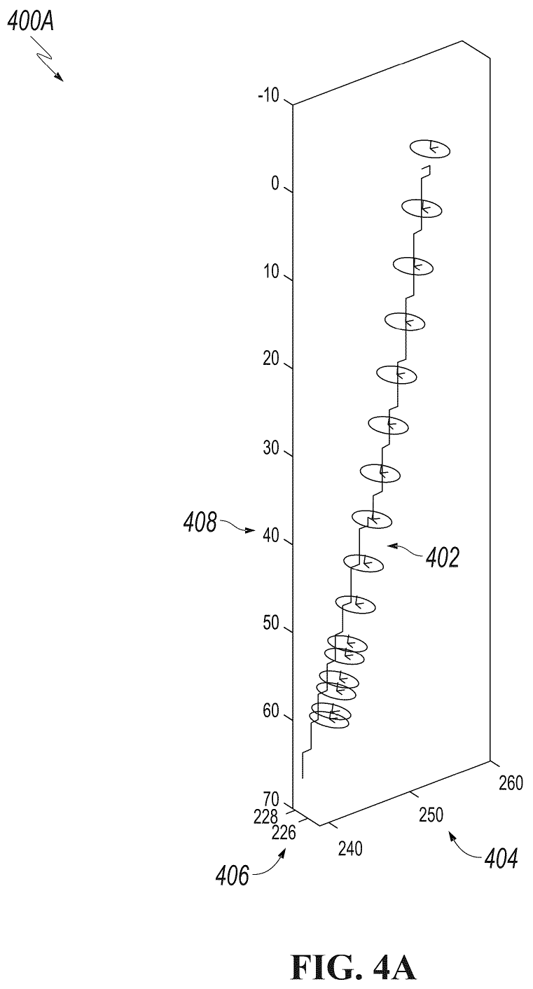

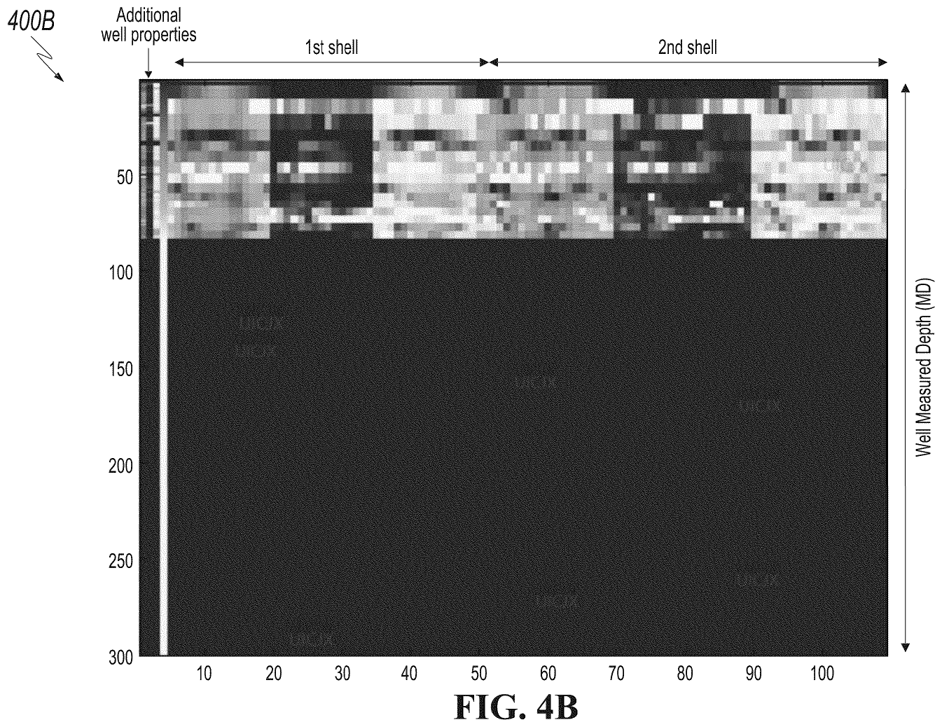

FIG. 4A illustrates an example of augmented data 400A, in accordance with some example implementations. The example of augmented data 400A can include results of data augmentation generated by expanding shell-formatted data that can be displayed by a graphical user interface (e.g., GUIs 126A, 126B, described with reference to FIG. 1A). The example of augmented data 400A, shown in FIG. 4A, can be used by trained prediction models to predict well production profiles and hydrocarbon reservoir depletion profiles well parameters in real time. The example of augmented data 400A can include augmented data generated by a data formatting system (e.g., data formatting system 136, described with reference to FIG. 1B). The example augmented data 400A can include shell-formatted data (e.g., shell-formatted data 300A, 300B, 300C described with reference to FIGS. 3A-3C) illustrating changes along the well path 402 and expanded along an x-axis 404, and a y-axis 406 in terms of the 3D vector equations to transform the circle into 3D coordinates. The rock property volumes are sampled at regularly spaced intervals. A second two-dimensional (2D) polar transformation is performed in the x-axis 404, and the y-axis 406 in order to regularly sample points along these circles before transformation into 3D volume along the x-axis 404, the y-axis 406, and a z-axis 408.

FIG. 4B illustrates an example of labeled shell-formatted data 400B, in accordance with some example implementations. The example of labeled shell-formatted data 400B can include expanded shell-formatted data that can be displayed by a graphical user interface (e.g., GUIs 126A, 126B, described with reference to FIG. 1A). The example of labeled shell-formatted data 400B, shown in FIG. 4B, can be used by trained prediction models to predict well production profiles and hydrocarbon reservoir depletion profiles well parameters in real time. The example of labeled shell-formatted data 400B can include data generated by a data formatting system (e.g., data formatting system 136, described with reference to FIG. 1B). The example labeled shell-formatted data 400B can include augmented shell-formatted data (e.g., shell-formatted data 300A, 300B, 300C described with reference to FIGS. 3A-3C), which for each shell, was sampled from the rock property volumes, was unraveled, and spliced together. The order of volume sampling in the illustrated example is porosity, permeability, and saturated gas. The example of labeled shell-formatted data 400B is normalized and/or padded to ensure that shell images of wells are of the same size and contain the full information along the length of the well. The example of labeled shell-formatted data 400B can include an additional piece of information, the well length that was also added to the shell image to give the models a reference feature which could be used to ignore padded areas. The length along the well only increases for valid well values, and remains constant after the length of the well was reached.

FIG. 5A illustrates an example of a prediction model 500A, in accordance with some example implementations. The example of a prediction model 500A can include a first prediction model (e.g., first prediction model 132A, described with reference to FIG. 1B) of a set of prediction models used to generate a prediction of well production profiles and hydrocarbon reservoir depletion profiles. The prediction model 500A includes a bidirectional LSTM model that facilitates a compact, quick-to-train model. The prediction model 500A can be trained to learn general broad patterns and process the input data (spatial domain) in a sequential manner, updating the output (time domain) via updates to its hidden memory state. The bi-directional nature of the prediction model 500A facilitates the model to learn relevant trends in both the time-to-spatial directions and vice-versa.

A variant of the described prediction model 500A, where a lag is introduced in the production profiles of the training data, is one way of forcing the network to process the majority of the spatial rock property information prior to outputting the production profile during the training process. Due to the sequence-based nature of the model, the output is dependent on the previously used data for training. The hidden state is used to remember or forget key patterns seen in the previous data. The prediction model 500A is configured as a compact model that reduces the chances of imprinting occurring due to the input and output being in different domains-spatial vs temporal. The prediction model 500A is useful for identifying key low-frequency-like trends that can be included in the outputted production profile, as the main themes can be the most likely learnt during training of the prediction model 500A. One additional modification that can be applied to the prediction model 500A is adding a large lag to the production profile. The lag facilitates for all or most of the input data to be seen and encoded into the hidden state prior to outputting the non-zero estimate of the production profile.

FIG. 5B illustrates another example of a prediction model 500B, in accordance with some example implementations. The example of a prediction model 500B can include a second prediction model (e.g., second prediction model 132B, described with reference to FIG. 1B) of a set of prediction models used to generate a prediction of well production profiles and hydrocarbon reservoir depletion profiles. The prediction model 500B includes a sequential model that provides a flexible and robust AI pipeline, providing a balance of performance and speed-to-train. Due to the sequential design of the prediction model 500B, an advantage of the prediction model 500B is that the weights in the network can be mapped back into the 3D domain with no further caveats, the activations being simpler to interpret when compared to the connectivity mapping process. Convolution steps are added within the prediction model 500B plus an average pooling layer to allow the model further flexibility in updating the weights. The data is passed through two fully connected layers to achieve behavior similar to an encoder-decoder arrangement.

The initial data channels of the prediction model 500B are amalgamated into a specified number of degrees of freedom where the number can be chosen based on performance of the trained network. A smaller number can also allow faster training time and less intense memory requirements. The prediction model 500B, having less internal degrees reduces the complexity of connecting activation along channels in the shell-image, to the associated connectivity map in 3D spatial domain. The convolutional layers of the prediction model 500B facilitate for further flexibility within the prediction model 500B, and the ability to amplify patterns arising within the data as it passes through and activates the model. An average pooling layer is inserted prior to the final fully connected layer, and is used to blend across the data-activated model and avoid over-dependence on one channel. The controlled channel dependence of the over-dependence on one channel avoids overfitting artefacts and prevents one degree of freedom over-dominating the overall fit of the prediction model 500B.

FIG. 5C illustrates another example of a prediction model 500C, in accordance with some example implementations. The example of a prediction model 500C can include a third prediction model (e.g., third prediction model 132C, described with reference to FIG. 1B) of a set of prediction models used to generate a prediction of well production profiles and hydrocarbon reservoir depletion profiles. The prediction model 500C can include a bifurcated graph model that splits the data into two parallel streams 502 and 504, where one has convolution applied, and the other does not. One feature of the prediction model 500C is the convolutions are both in the network's spatial domain (rather than channel domain as in the sequential), conditioning the input data to be input in a particular format (as “stacked” shell-formatted data). The formatting requirement makes the prediction model 500C highly extensible, facilitating addition of a rich range of features/properties which are likely to be correlated to connectivity, such as first and second derivative information and rock-quality index information.

In the network, one fully connected layer of the prediction model 500C resides on either part of the bifurcation. To make the recombination of the parallel streams 502 and 504 more effective, the shell-format data is modified for the prediction model 500C. Each feature (e.g., well, first and second shell porosity and permeability) is converted into a single image, all of the same size as the second shell image. The second shell being selected for being the largest part of the shell-image. In some implementations, additional (e.g., synthetic) data can be infilled to increase the respective size, or linear interpolation can be used to infill data, which can ensure the angle-index relationships are maintained in the shell-domain data. The results of the prediction model 500C include a stacked set of feature images, one for each rock property-shell layer combination. For the described reason, the generated format can be called a shell-image-stack. As well as having easier recombination properties after bifurcation, the shell-image-stack format also means the convolution layer has a more traditional image-like behavior on the data, in terms of filter weights. Each feature has customized filters to enhance particular patterns, so there is no single filter which impacts multiple filters at once. This feature-specific filter fitting can be a useful property when each feature is conditioned to be processed individually. The enhanced shell-image-stack format also has a very useful property that it is very easy to add new features, by simply adding it to the end of the stack. The prediction model 500C facilitates addition of other features useful in connectivity mapping. Some other features include derivative information (first derivative-Jacobian, second derivative-Laplacian) for all rock properties, and also rock quality index expressed as a function of the ratio between the permeability and porosity. Any useful feature could be used here, and makes the described prediction model 500C particularly flexible, and extendable.

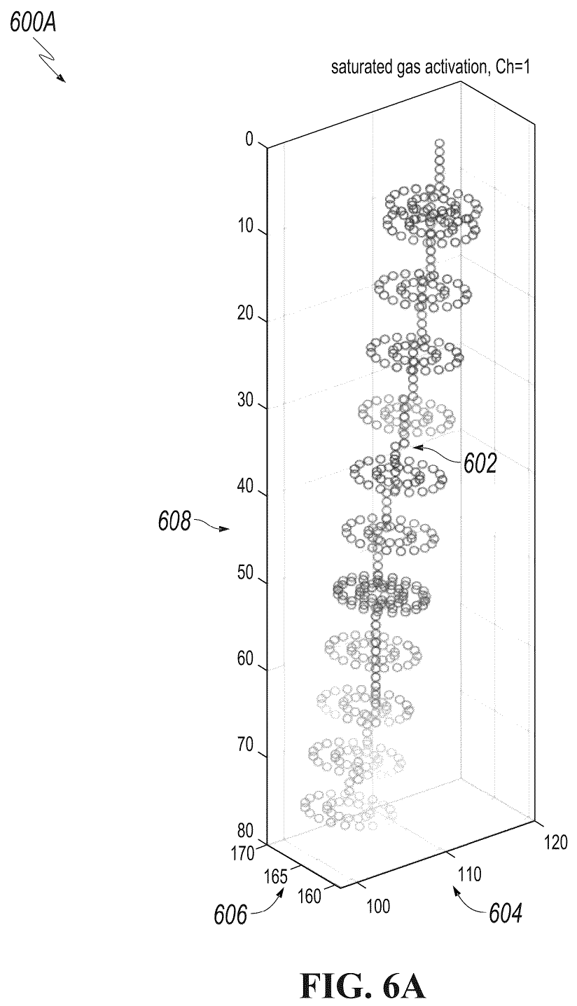

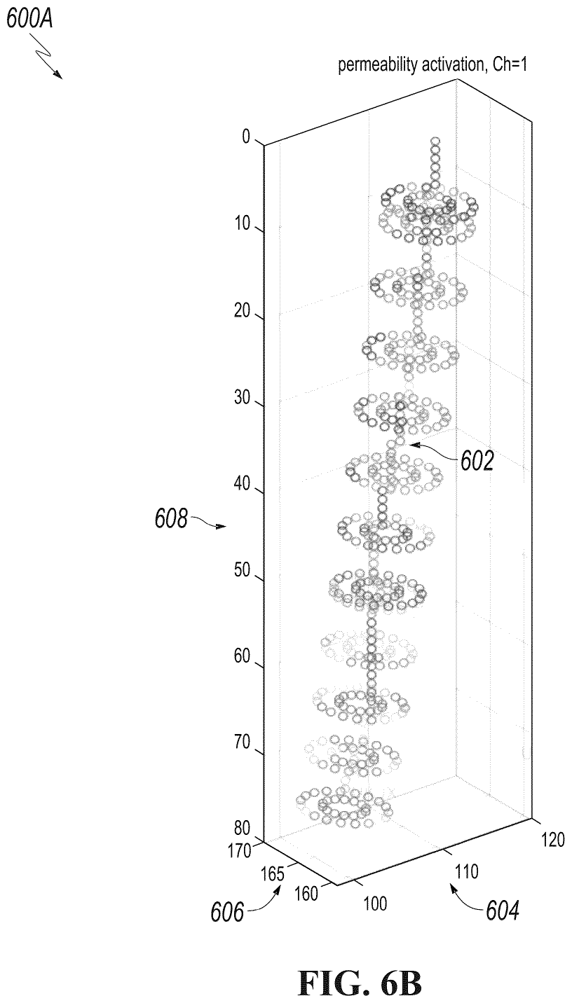

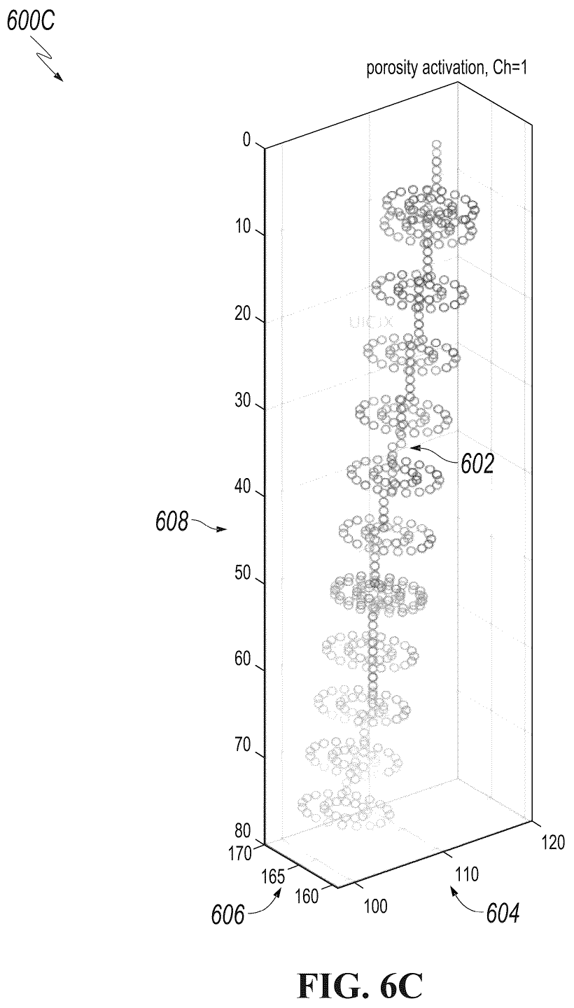

FIG. 6A illustrates an example of a network activation 600A, in accordance with some example implementations. FIG. 6B illustrates another example of a network activation 600B, in accordance with some example implementations. FIG. 6C illustrates another example of a network activation 600C, in accordance with some example implementations. The examples of network activation 600A, 600B, 600C include a novel visualization that can be displayed by a graphical user interface (e.g., GUIs 126A, 126B, described with reference to FIG. 1A). The examples of network activation 600A, 600B, 600C provide an insight on the connectivity mapping emulation that has been created. Usually, the network weights are a flattened array, with one weight parameter for each possible combination of index locations on the shell-image data. During the creation of the shell-image, it can be possible to create an inverse mapping, allowing the 3D position around the well to be determined for each index location in the shell-image. Given a well path 602 it is possible to visualize the network's attention to the regions around the well along the x, y, and z axes 604, 606, 608, for each rock property volume and degree of freedom for the network. The visualization of network activation 600A, 600B, 600C shows network attention, which is how the network determines an estimated production profile.

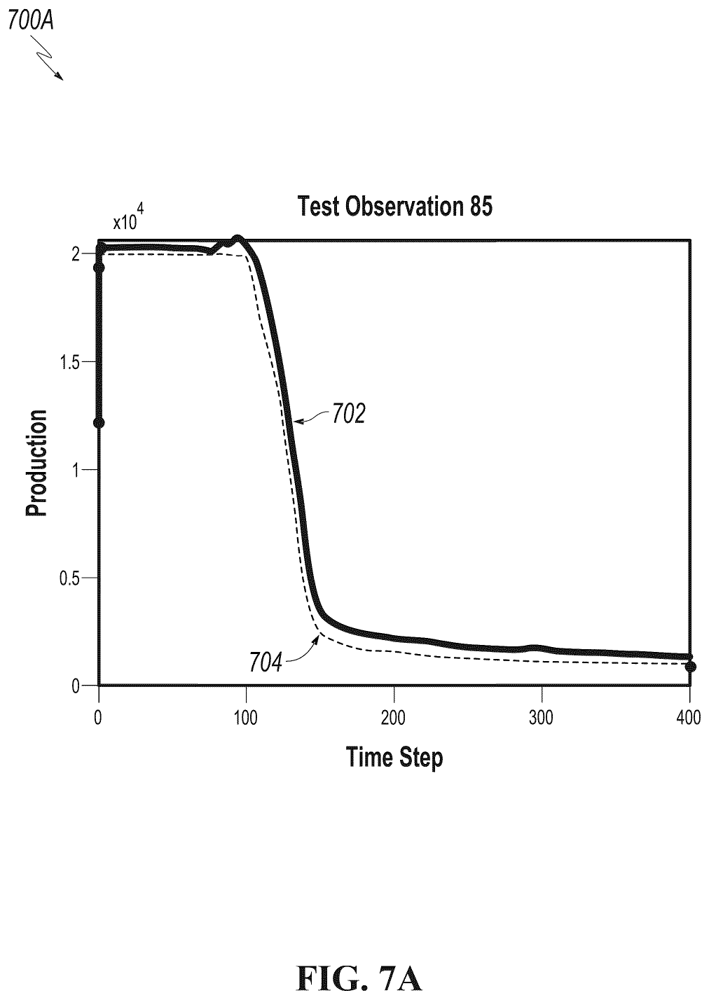

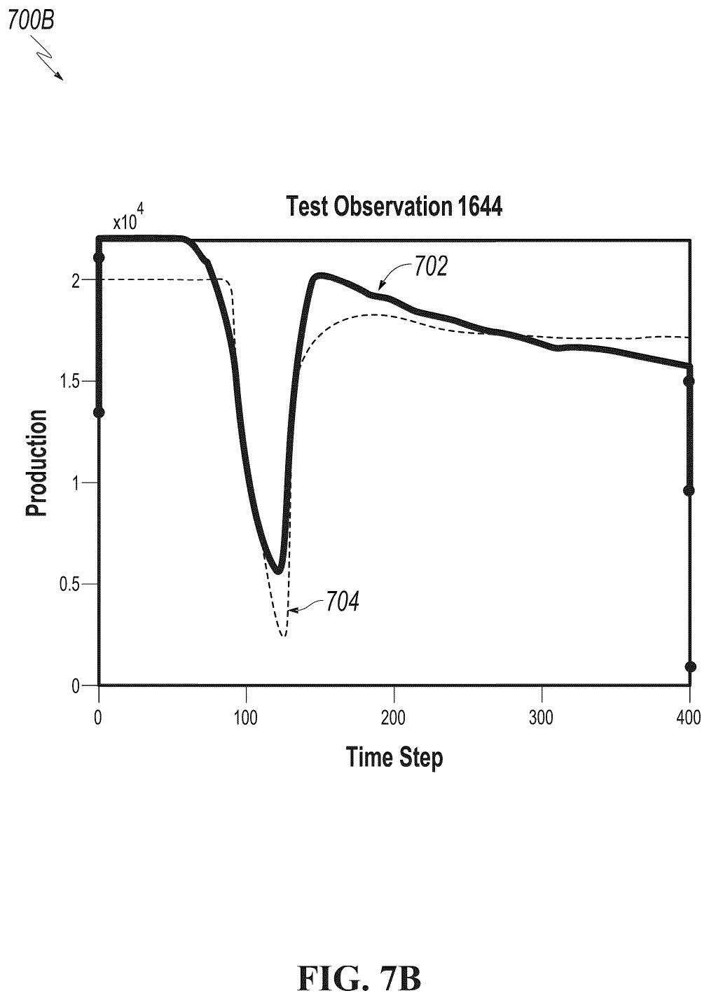

FIG. 7A illustrates an example production profile 700A, in accordance with some example implementations. FIG. 7B illustrates another example production profile 700B, in accordance with some example implementations. The example production profiles 700A, 700B can be generated by prediction models (e.g., prediction models 132A, 132B, 132C described with reference to FIG. 1B and prediction models 500A, 500B, 500C described with reference to FIGS. 5A-5C) and can be displayed by a graphical user interface (e.g., GUIs 126A, 126B, described with reference to FIG. 1A). The example production profiles 700A, 700B can be matched to a sampling period and date range of the production profiles used in the training data of the prediction models (e.g., 78-year daily production FIG. 2023-2100), subsampled to 400 equally spaced periods). The range of production profiles generally vary from initially high production with the characteristic drop-off, to consistently high production with a mid-period drop-off. The prediction models correlate the characteristics in the well production profiles to the patterns and trends in the rock-property volumes around the well path concerned. FIGS. 7A and 7B show some example predictions of well production profiles 702 generated by the described prediction models alongside the known production profile 704.

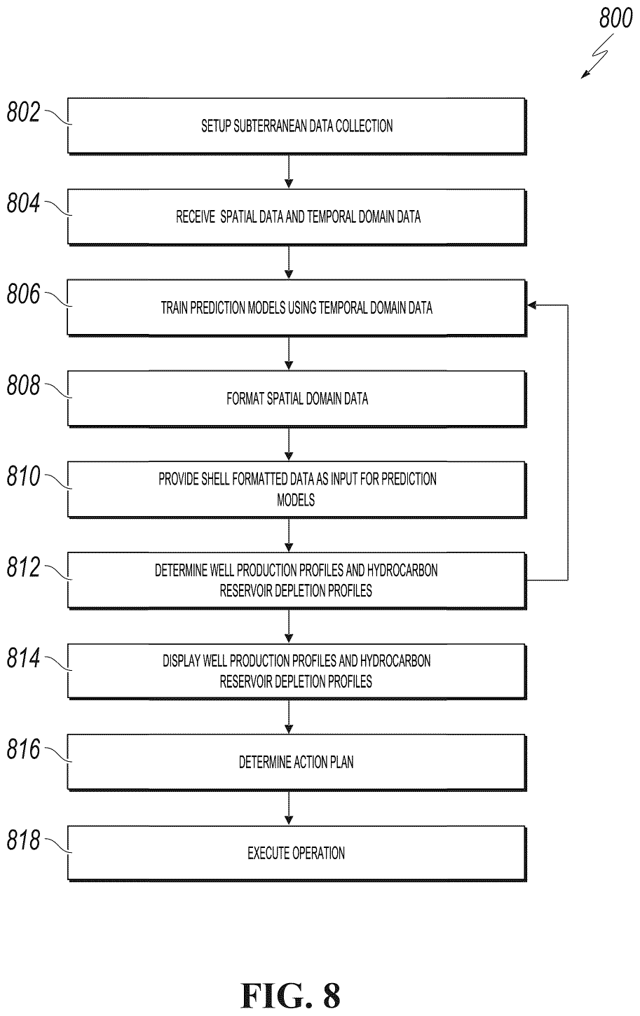

FIG. 8 depicts a flowchart illustrating an example process 800 for prediction of well production profiles in hydrocarbon reservoirs, in accordance with some example implementations. Referring to FIGS. 1A and 1B, the process 800 can be performed by any components of the example system 100. The example process 800 can be executed using, e.g., any component of the example system 100 described with reference to FIG. 1A or example system 101 described with reference to FIG. 1B. Operations of the process 800 are described below for illustration purposes only. Operations of the process 800 can be performed by any appropriate device or system, e.g., any appropriate data processing apparatus. Operations of the process 800 can also be implemented as instructions stored on a computer readable medium which can be non-transitory. Execution of the instructions causes one or more data processing apparatus to perform operations of the process 800.

At 802, collection of data using multiple probes is configured, by one or more processors configured to manage probe data collection. The management of probe data collection can include setting up a frequency and/or a schedule of collecting data from the probes as described with reference to FIGS. 1A and 1B. Each of the probes can be configured to activate data collection and/or transmission according to a respective schedule defining a frequency of data collection and a duration of each collection duration. The probes can be configured to collect data continuously (according to the respective schedule) or can have a set trigger that initiates data collection in response to detection of one or more conditions for data collection. The conditions can be defined based on safety regulations and operational conditions regarding an operational status of machines operating at the wellbore. In some implementations, a list of safety standards and controls are processed to initiate a real time safety compliance assessment identifying the target system components and coupled probes to be activated for collecting probe data. The probe data can be collected by probes included in operating wells and observation wells within a field or can be generated by devices measuring rock properties of samples extracted from a subterranean formation. The rock properties can include porosity, permeability, saturated gas content, and clay content change. Each of the rock properties can be associated with a measurement (or sample collection) location forming 3D spatial data. Rock property volumes are sampled at the well location, and nearby regions. Multiple samples nearby the well allows rates of change to be measured, emulating the connectivity mapping process more effectively. The sampled data is then converted into “shell” format, due to the sampling along the well forming a series of concentric shells around the well bore, which the AI models expect. Three AI models are made available here, each with particular advantages. The estimated production profile is then output, a 1D (time-series) profile of expected production over time. Well production profiles can be collected for functional wells as temporal domain data. The temporal domain data for producing wells can be collected in parallel with respective 3D spatial data.

At 804, the spatial domain data and the temporal domain data are received, by the one or more processors of a server system configured to process the probe data. The received spatial domain data characterizes rock properties within a subterranean volume including a hydrocarbon reservoir. The temporal domain data characterizes temporal variations of well productions. In some implementations, multiple sets of spatial domain data corresponding to multiple wells are received. The temporal domain data can correspond to a portion of the spatial domain data characterizing a portion of the wells.

At 806, the temporal domain data corresponding to a portion of the spatial domain data characterizing a portion of the wells is used to train prediction models. The prediction models include a bi-directional long short-term memory model, a sequential model, and a bifurcated graph model. The training can include processing of multiple training datasets to train the prediction models to generate well production profiles and hydrocarbon reservoir depletion profiles for different types of well characteristics, using different types of rock properties. The training can include a quality control provided by subject-matter experts that evaluate the quality of the generate well production profiles and hydrocarbon reservoir depletion profiles. As another example, the training dataset can include a listing of petrophysical parameters (including well production profiles) and probability-weighted listings of pluralities of potentially corresponding rock properties. As another example, the training dataset can include charts, graphs, and/or other data structures relating petrophysical parameters to potentially corresponding rock properties. As yet another example, the training dataset can include representations of subsurface regions (e.g., models and/or images) with identified rock properties (e.g., labels). In some implementations, a combination of any two or more types of rock type datasets can be included in the training dataset. In some implementations, the training datasets can be generated from existing datasets (e.g., representations of known subsurface regions) of the spatial domain data and the temporal domain data. For example, existing subsurface data can be manually and/or automatically labeled to identify petrophysical parameters and corresponding rock properties. In some implementations, the training datasets can be generated by simulation to synthesize spatial domain data and temporal domain data, including petrophysical parameters and corresponding rock properties. In some implementations, a combination of any two or more of the training data set generation methods can be utilized to generate the training dataset. A synthesized training dataset can be characterized as including representations of 3D well models within subterranean regions corresponding to the spatial domain data and temporal domain data represented at particular frequencies and various scales of rock properties. In some implementations, if the first part of productivity curve is known, the known information can be fed back into the prediction models for farther training before forecasting.

At 808, spatial domain data is formatted as shell-formatted data including a shell format processable by prediction models, the shell format comprising a series of concentric shells within a spatial volume at different depths around a wellbore (e.g., along a well path). The well-path is used to build a set of concentric cylinders from which the rock property volumes are sampled from. The cylindrical formatted data are reformatted (unraveled) into “shells” which are spliced into one large image. For the Bifurcated graph AI model, an additional modification is also made to facilitate addition of any additional features (synthetic data) to improve results. The method presented outputs an estimated production profile for a given well path. The rock property volumes can be sampled along the well path. In order to better emulate the connectivity mapping process, the rock property volumes can be sampled as a set of concentric cylinder “shells” around the well bore, such that enough information is present which correlates to rates of rock property changes along the well path. In order to create the concentric shells, the direction vectors and plane equations are calculated for a series of well-spaced discs along the well path.

Well paths are parameterized using a multi-parameter curve for seven parameters. Parameterizing the curve allows the instantaneous tangent vector to be calculated, which represents the plane-normal vector for a disc centered at that point. The domain of parameterization is in cylindrical polar coordinates. The domain of parameterization simplifies the gradient calculation to be mainly in a single dimension in a plane of the well. The seven parameters (A, B, C, theta, X, Y, L) are determined along the well depth z=Ar2+Br+C, r and theta represents the coordinates in polar coordinates transformation, considering the intersection of X, Y as being the spud point of the well and L being the well length.

The tangent vector is defined as (r, theta, z)=(1,0,2A+B), and the perpendicular vector is defined via (x−a).b=0 or a (x−x1)+b (y−y1)+c (z−z1)=0, where (a, b, c) is normalized tangent vector and (x1,y1,z1) is the point on the well path being evaluated.

A circle can be defined at the edge of the disc having the radius d, with the equation X′2+Y′2=d. It is assumed that X′ and Y′ are direction vectors along the 2D plane, where Y′ is aligned with increasing Z (e.g., 1 step in z-direction, fixing y=0).

It is possible to expand X′ and Y′ in terms of the 3D vector equations to transform the circle into 3D coordinates. The rock property volumes can be sampled at regularly spaced intervals. A second 2D polar transformation is performed in X′ and Y′ in order to regularly sample points along these circles before transformation into 3D. For the described method, 2 sets of concentric cylinders, or tubes, are used, where d=15 and 20.

The rock properties including the porosity, the permeability, and the saturated gas volumes are sampled at the 3D coordinate positions of the well, first and second concentric shells. The rock properties are “unraveled” and spliced together into one 2D image, called the “shell” format or domain. Each shell, sampled from the rock property volumes, is unraveled and spliced together. The order of volume sampling in the illustrated example is porosity, permeability, and saturated gas. Padding can be added after the end of the well to ensure all wells' shell images are of the same size and contain the full information along the length of the well. An additional piece of information, the well length can also be added to the shell image to give the models a reference feature which could be used to ignore padded areas. The length along the well only increases for valid well values, and remains constant after the length of the well has been reached.

Standard linear interpolation can be used to sample the rock property volumes at the selected coordinates. The coordinates can be stored, so for each pixel coordinate in the shell domain, the full 3D coordinate is known in the spatial domain, which forms the inverse transformation of the 3D to shell space transformation. The inverse transformation is important for the prediction model activation visualization method.

The rock property data can be shifted according to two transformations in the perforated parts of the well-along the well and rotating around the well. The well, first and second concentric shells can be globally shifted and/or rotated in the perforation region of the well, which is responsible for the production profile over the lifetime of the well. In the shell domain, once the perforated region of the well is known, the transformations can be performed by circularly shifting the rock properties vertically (along the well shift) or horizontally (rotational).

The production profiles can be correlated to a particular property of the input data. For example, the rate of change of permeability, perpendicularly away from the well-bore can be calculated and added as an additional part of the input data. The added value can also include Jacobian transforms or Laplace transforms that supplement porosity, permeability, gas saturation, as well as rock quality index data, to allow patterns to be discovered by the multiple networks.

At 810, shell-formatted data is provided as input for the trained prediction models. The bifurcated network was designed to allow case-of-adding these additional input datasets from which to uncover novel patterns and trends. The bi-LSTM network processes data sequentially, so is likely to uncover broader patterns, more applicable to the whole production profile. The bi-LSTM (as opposed to simply LSTM) means during training the weight updates are impacted by the entire production profile, which is important as the data is in the spatial domain—the later part of the production profile may be impacted by the shallower part of the input data, so training in both directions allows the network to uncover patterns in both directions of the domain mapping. The sequential model (similar to the bifurcated graph model but without the bifurcation) enhances discovery of patterns as the weights in the network are more directly mappable back to the 3D spatial domain of the data. The sequential model can be useful for visualization of patterns found during training, which coupled with an iterative feedback loop, facilitates training.

At 812, well production profiles and hydrocarbon reservoir depletion profiles are determined, by the trained prediction models. Three different AI models are proposed, each offering different advantages but all approximating the connectivity mapping process. The three models are a bi-directional LSTM model, a sequential model, and a bifurcated graph. The Bi-directional LSTM model offers a compact, quick-to-train model. It is able to learn general broad patterns and process the input data (spatial domain) in a sequential manner, updating the output (time domain) via updates to its hidden memory state. The bi-directional nature allows the model to learn important trends in both the time-to-spatial directions and vice-versa. A variant of the described approach, where a lag is introduced in the production profiles of the training data, is one way of forcing the network to process the majority of the spatial rock property information prior to outputting the production profile during the training process. Due to the sequence-based nature of the model, the output is purely dependent on the previously seen data. The hidden state is used to remember or forget key patterns seen in the previous data. The described method uses a model that is compact, and reduces the chances of imprinting occurring due to the input and output being in different domains-spatial vs temporal. The described method is useful when you want key low-frequency-like trends to be output in the production profile, as these main themes can be the most likely learnt during training of the model. One additional modification that can be applied is adding a large lag to the production profile. The input data can be seen and encoded into the hidden state prior to outputting the non-zero estimate of the production profile. The sequential model provides a flexible and robust prediction pipeline, providing a balance of performance and speed-to-train. Due to the sequential design, an advantage of the described model is that the weights in the network can be mapped back into the 3D domain with no further caveats, therefore meaning the activations are simpler to interpret when compared to the connectivity mapping process. Convolution steps are added within the model plus an average pooling layer to allow the model further flexibility in updating the weights.

The data are passed through two fully connected layers to achieve behavior similar to an encoder-decoder arrangement. The initial data channels are amalgamated into a specified number of degrees of freedom, where the number can be chosen based on performance of the trained network. A smaller number might also allow faster training time and less intense memory requirements. Explained in more detail under the visualization of network activation section, having less internal degrees reduces the complexity of connecting activation along channels in the shell-image, to the associated connectivity map in 3D spatial domain. Convolutional layers allow for further flexibility within the model, and the ability to amplify patterns arising within the data as it passes through and activates the model. An average pooling layer is inserted prior to the final fully connected layer, and is used to blend across the data-activated model and avoid over-dependence on one channel. The described process avoids overfitting artefacts and prevents one degree of freedom over-dominating the overall fit of the model.

The bifurcated graph model splits the data into two parallel streams, where one has convolution applied, and the other does not. One advantage of the described model is the convolutions are both in the network's spatial domain (rather than channel domain as in the sequential), requiring the input data to be input in a particular fashion. The bifurcation makes the model highly extensible, and can be used to add a rich range of features/properties, which are correlated to connectivity, such as first and second derivative information and rock-quality index information.

In the network, one fully connected layer resides on either part of the bifurcation. To make the recombination of these paths more effective, the shell-format data is modified for the described type of model. Each feature (e.g., well, first and second shell porosity, and permeability) is converted into a single image, of the same size as the second shell image. The second shell is the largest part of the shell-image. The additional data can be infilled to be reformatted according to a selected size. For example, linear interpolation can be used to infill data, which can ensure that the angle-index relationships are maintained in the shell-domain data. The results can include a stacked set of feature images, one for each rock property-shell layer combination. The format can be called a shell-image-stack. As well as having easier recombination properties after bifurcation, the described format also means the convolution layer has a more traditional image-like behavior on the data, in terms of filter weights. Each feature has customized filters to enhance particular patterns, so there is no single filter which impacts multiple filters at once. The feature-specific filter fitting can be a useful property when each feature can be processed individually. The enhanced shell-image-stack format also has useful property that it is easy to add new features (synthetic data), by simply adding the new features to the end of the data stack.

The output of the prediction models is the production profile, which is matched to the sampling period and date range of the production profiles used in the training data. For example, a 78-year daily production FIG. 2023-2100), subsampled to a number (e.g., 400) equally spaced periods. The range of production profiles varied from initially high production with the characteristic drop-off, to consistently high production with a mid-period drop-off. The models correlate these characteristics in the production profiles to the patterns and trends in the rock-property volumes around the well path concerned.

In some implementations, generating the well production profiles and hydrocarbon reservoir depletion profiles can include perturbing the input data to generate a range of predictions. As the productivity begins to be output, the collected data can be used to eliminate some of the estimates, leaving a more accurate forecast. In some implementations, productivity testing results can be used to recalibrate some of the input data, such as the permeability data, and then recalculate the production profiles. Another possibility can be to subdivide the production profiles into shorter time sections (and then adding time, or time-section as an additional parameter in the training data). After training, prediction can be based on the time-section parameter. As production becomes known, the time-section value can be calculated from the actual data, allowing the prediction of subsequent production profiles.

At 814, the well production profiles and hydrocarbon reservoir depletion profiles are displayed by a graphical user interface, as described with reference to FIGS. 7A and 7B. The well production profiles and hydrocarbon reservoir depletion profiles can vary by rock property and can be formatted to be displayed according to a degree of freedom within the network. By evaluating the attention paid to each rock property around the well, it is possible to display the relationships the trained network is attempting to establish in a 3D sense, subsequently facilitating a correlation to be made to the connectivity mapping process. The well production profiles and hydrocarbon reservoir depletion profiles can show slice-based views of the connectivity and an overlay method can be used to show where both the rock property and attention are similar or different.

At 816, an action plan is generated, by the one or more processors of the server system, to manage well production. The action plan can be identified by machine learning models (e.g., recurrent neural networks with a multi-layer network topology) trained and fine-tuned to generate a set of actions to manage well production by operating equipment, wells, pumps, drills, and other industrial machines configured to manage well production. The trained machine learning models can be configured to operate in active mode, within the server system, facilitating automatic action plan implementation. For example, the trained machine learning models can trigger a modification of system component operations for adjusting pressure, temperature, and/or volume, for example by valve and/or pump control. In some implementations, more than one trained machine model can be placed in active mode concurrently (that is, overlapping in a time), for example, for evaluating well operation safety considering different evaluation methods (e.g., one analyzing pressure, another analyzing temperature, another analyzing injected volume relative to a detected parameter, such as seismic data magnitude).

At 818, the action plan is transmitted to be displayed by a graphical user interface and is executed. The action plan includes an automatic selection of actions that can be triggered to be automatically performed based on system configurations. The well production actions include, among other things, notification to an end user of an identified risk, compensation through well operation adjustment to mitigate the detected risk, and communication of the sensed vulnerability and risk to a field operator or well manager to fortify the safety and integrity of the well and of the reservoir. In some implementations, transmission for display of action plans and the remedial actions can be adjusted relative to a traffic light system that categorizes safety events (e.g., micro-seismic events) relative to determined potential consequences associated with the action plan. For example, automatic alerts can be sent by email and text messages for minor and medium level safety risk incidents associated to consequences indicative of well operation inefficiency and automatic performance of one or more operations can be implemented for critical events associated to potentially critical consequences suggesting a current or future well inoperability or potentially leading to critical events leading to destruction of well and reservoir. The alerts can be displayed as a notification summarizing the detected risk, such as a notification indicating that hydrocarbon storage status is approaching a limit of an operational range for a particular location. The operation can include a modification of a component of the system (adjustment of at least one device configuration setting), such as partly or completely closing one or more valves to regulate flow through the well, or activating a fan to regulate temperature, or activating or modifying parameters of a pump to control a flow rate. In response to executing the operation, an updated well production score can be determined and compared to a reference safety or target score. The comparison can indicate a success level of the well management action plan and consequences can be used for further training of the machine learning models. If the updated safety score is greater than or equal to the reference score, an assessment report is provided for display, to the graphical user interface. The assessment report can be provided as a full or as a partially customized assessment. For example, the graphical user interface provides customizable features used for configuring the assessment reporting results and recommendations to monitor the well production volume, the health of the hydrocarbon storage reservoir, and well operation safety.

The example process 800 generates a fast-track estimate of the production profile, significantly faster than the standard, simulation-based, connectivity mapping process. The example process 800 can be integrated as part of an overall algorithmic workflow. One enabled workflow is well trajectory optimization. Imagine a cost function has been created which is has as independent input, the parameters which determine well path trajectory, shape and length. For a given realization of these well path parameters the cost function outputs a measure of the closeness to a desired production profile. The production profile desired can be defined in terms of key properties such as initial production rate, drop off, cumulative production and so on. The optimizer can now vary these parameters to design or modify a well in order to best match a desired production profile over time. The described level of detailed design is a novel achievement, enabled by the ability to rapidly estimate production profiles due to the presented technique. Without the described technique, each iteration of the optimization algorithm would require the entire connectivity mapping workflow to be undergone, which would be impractical. The example process 800 is used to monitor real-time data of crucial well operation parameters, such as hydrocarbon flowrates, pressures, temperatures, and other geo-mechanical parameters of hydrocarbon storage wells and reservoir. The example process 800 incorporates real-time micro-seismic and downhole pressure and temperature monitoring features. The data generated during the example process 800 is displayed on a user-friendly interface including various dashboards and reports, enabling a comprehensive performance analysis at field and well levels. The data generated during the example process 800 can automatically integrate surface and subsurface data, including micro-seismic data, to automatically update well production profile engines and issue recommendations for well and reservoir management.

FIG. 9 depicts a block diagram illustrating a computing system 900, in accordance with some example implementations. Referring to FIGS. 1A and 1B, the computing system 900 can be used to implement the server system 102 and/or any other components of the example system 100.

As shown in FIG. 9, the computing system 900 can include a processor 910, a memory 920, a storage device 930, and input/output devices 940. The processor 910, the memory 920, the storage device 930, and the input/output devices 940 can be interconnected using a system bus 950. The processor 910 is capable of processing instructions for execution within the computing system 900. Such executed instructions can implement one or more components of, for example, the example system 100. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided using the input/output device 940.

The memory 920 is a computer readable medium such as volatile or non-volatile that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces.

According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 940. The user interface can be generated and presented to a user by the computing system 900 (e.g., on a computer screen monitor).

One or more aspects or features of the subject matter described herein can be realized in digital electronic circuitry, integrated circuitry, specially designed ASICs, field programmable gate arrays computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

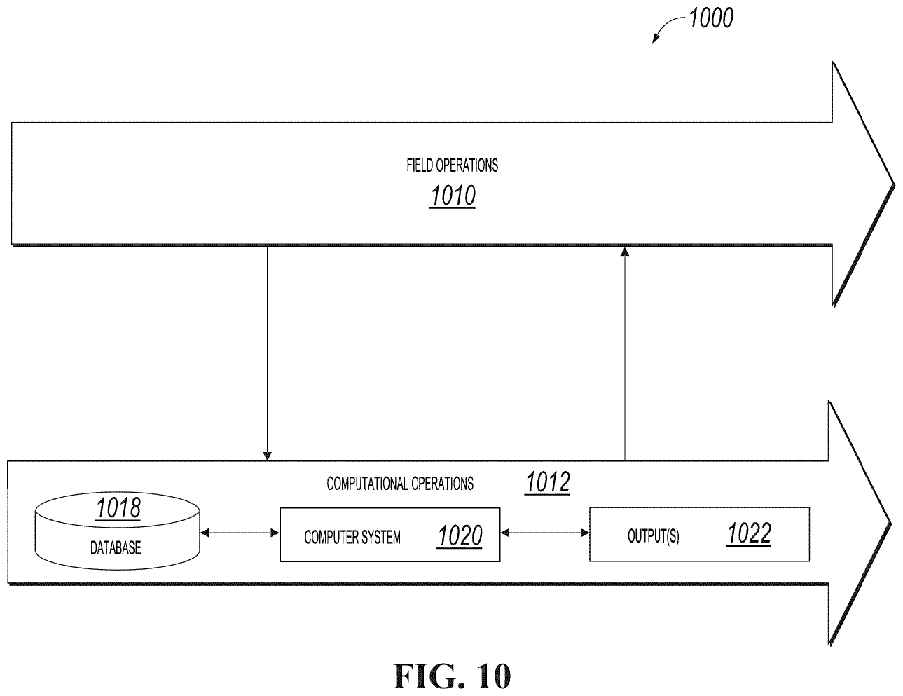

FIG. 10 illustrates hydrocarbon production operations 1000 that include both one or more field operations 1010 and one or more computational operations 1012, which exchange information and control exploration for the production of hydrocarbons. In some implementations, outputs of techniques of the present disclosure can be performed before, during, or in combination with the hydrocarbon production operations 1000, specifically, for example, either as field operations 1010 or computational operations 1012, or both.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively, or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate 3D maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a hydrocarbon or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or hydrocarbon well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

The preceding figures and accompanying description illustrate example processes and computer implementable techniques. The environments and systems described above (or their software or other components) can contemplate using, implementing, or executing any suitable technique for performing these and other tasks. It can be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of particular implementations and generally associated methods, alterations and permutations of these implementations, and methods can be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it can be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1.A computer-implemented method, comprising: receiving, from one or more probes, spatial domain data and temporal domain data, the spatial domain data characterizing rock properties within a subterranean volume comprising a hydrocarbon reservoir and the temporal domain data characterizing temporal variations of well productions; formatting the spatial domain data as shell-formatted data comprising a shell format processable by prediction models, the shell format comprising a series of concentric shells within a spatial volume at different depths around a well bore; providing the shell-formatted data as input for the prediction models to generate a plurality of well production profiles and hydrocarbon reservoir depletion profiles, the prediction models being trained using the temporal domain data; and managing hydrocarbon production from the hydrocarbon reservoir based on the production profiles and the hydrocarbon reservoir depletion profiles.
Example 2. The computer-implemented method of the preceding example, wherein the prediction models comprise a bi-directional long short-term memory model, a sequential model, and a bifurcated graph model.
Example 3. The computer-implemented method of any of the preceding examples, wherein the bi-directional long short-term memory model sequentially processes the shell-formatted data and patterns of the production profiles.
Example 4. The computer-implemented method of any of the preceding examples, wherein the sequential model comprises two fully connected layers and weights that are adjusted to determine the patterns of the well production profiles, the weights being directly mappable to the spatial domain data.
Example 5. The computer-implemented method of any of the preceding examples, wherein the bifurcated graph model splits the shell-formatted data into two parallel streams and applies convolution to one of the two parallel streams to determine patterns in the well production profiles.
Example 6. The computer-implemented method of any of the preceding examples, wherein formatting the spatial domain data as shell-formatted data comprises: performing data augmentation by generating synthetic data and adding the synthetic data to the spatial domain data to generate augmented data.
Example 7. The computer-implemented method of any of the preceding examples, wherein performing the data augmentation comprises: shifting a first portion of the spatial domain data and rotating a second portion of the spatial domain data.
Example 8. The computer-implemented method of any of the preceding examples, wherein formatting the spatial domain data as shell-formatted data comprises: applying standard linear interpolation to sample the spatial domain data for a set of spatial coordinates.
Example 9. The computer-implemented method of any of the preceding examples, wherein formatting the spatial domain data as shell-formatted data comprises: labeling the shell-formatted data to generate labeled shell formatting data.
Example 10. The computer-implemented method of any of the preceding examples, wherein the rock properties comprise porosity, permeability, saturated hydrocarbon content, and clay content change.
Example 11. The computer-implemented method of any of the preceding examples, further comprising: generating a plot of the shell-formatted data that maps rock samples to areas of the plot, wherein points on the plot are plotted relative to an x-axis of effective porosity and a y-axis of total clay, and wherein a color or grayscale of a point is mapped to hydrocarbon volume scale; and presenting the plot in a graphical user interface.
Example 12. A computer-implemented system, comprising: one or more data sources of petrophysical evaluation results that have been determined and collected for a tight hydrocarbon sandstone reservoir; one or more graphical user interfaces (GUIs) for interacting with users and presenting information based on an analysis of the petrophysical evaluation results; one or more processors; and a non-transitory computer-readable storage medium coupled to the one or more processors and storing programming instructions for execution by the one or more processors, the programming instructions instructing the one or more processors to perform operations comprising: receiving, from one or more probes, spatial domain data and temporal domain data, the spatial domain data characterizing rock properties within a subterranean volume comprising a hydrocarbon reservoir and the temporal domain data characterizing temporal variations of well productions; formatting the spatial domain data as shell-formatted data comprising a shell format processable by prediction models, the shell format comprising a series of concentric shells within a spatial volume at different depths around a well bore; providing the shell-formatted data as input for the prediction models to generate a plurality of well production profiles and hydrocarbon reservoir depletion profiles, the prediction models being trained using the temporal domain data; and managing hydrocarbon production from the hydrocarbon reservoir based on the production profiles and the hydrocarbon reservoir depletion profiles.
Example 13. The computer-implemented system of the preceding example, wherein the prediction models comprise a bi-directional long short-term memory model, a sequential model, and a bifurcated graph model, wherein the bi-directional long short-term memory model sequentially processes the shell-formatted data and patterns of the production profiles, wherein the sequential model comprises two fully connected layers and weights that are adjusted to determine the patterns of the well production profiles, the weights being directly mappable to the spatial domain data.
Example 14. The computer-implemented system of any of the preceding examples, wherein the bifurcated graph model splits the shell-formatted data into two parallel streams and applies convolution to one of the two parallel streams to determine patterns in the well production profiles.
Example 15. The computer-implemented system of any of the preceding examples, wherein formatting the spatial domain data as shell-formatted data comprises: performing data augmentation by generating synthetic data and adding the synthetic data to the spatial domain data to generate augmented data and by shifting a first portion of the spatial domain data and rotating a second portion of the spatial domain data.
Example 16. The computer-implemented system of any of the preceding examples, wherein formatting the spatial domain data as shell-formatted data comprises: applying standard linear interpolation to sample the spatial domain data for a set of spatial coordinates.
Example 17. The computer-implemented system of any of the preceding examples, wherein formatting the spatial domain data as shell-formatted data comprises: labeling the shell-formatted data to generate labeled shell formatting data.
Example 18. The computer-implemented system of any of the preceding examples, wherein the rock properties comprise porosity, permeability, saturated hydrocarbon content, and clay content change.
Example 19. The computer-implemented system of any of the preceding examples, wherein the operations further comprise: generating a plot of the shell-formatted data that maps rock samples to areas of the plot, wherein points on the plot are plotted relative to an x-axis of effective porosity and a y-axis of total clay, and wherein a color or grayscale of a point is mapped to hydrocarbon volume scale; and presenting the plot in a graphical user interface.
Example 20. A non-transitory computer-readable media encoded with a computer program, the computer program comprising instructions that when executed by one or more computers cause the one or more computers to perform operations comprising: receiving, from one or more probes, spatial domain data and temporal domain data, the spatial domain data characterizing rock properties within a subterranean volume comprising a hydrocarbon reservoir and the temporal domain data characterizing temporal variations of well productions; formatting the spatial domain data as shell-formatted data comprising a shell format processable by prediction models, the shell format comprising a series of concentric shells within a spatial volume at different depths around a well bore; providing the shell-formatted data as input for the prediction models to generate a plurality of well production profiles and hydrocarbon reservoir depletion profiles, the prediction models being trained using the temporal domain data; and managing hydrocarbon production from the hydrocarbon reservoir based on the production profiles and the hydrocarbon reservoir depletion profiles.

What is claimed is:

1. A computer-implemented method, comprising:
receiving, from one or more probes, spatial domain data and temporal domain data, the spatial domain data characterizing rock properties within a subterranean volume comprising a hydrocarbon reservoir and the temporal domain data characterizing temporal variations of well productions;
formatting the spatial domain data as shell-formatted data comprising a shell format processable by prediction models, the shell format comprising a series of concentric shells within a spatial volume at different depths around a well bore;
providing the shell-formatted data as input for the prediction models to generate a plurality of well production profiles and hydrocarbon reservoir depletion profiles, the prediction models being trained using the temporal domain data; and
managing hydrocarbon production from the hydrocarbon reservoir based on the production profiles and the hydrocarbon reservoir depletion profiles.

2. The computer-implemented method of claim 1, wherein the prediction models comprise a bi-directional long short-term memory model, a sequential model, and a bifurcated graph model.

3. The computer-implemented method of claim 2, wherein the bi-directional long short-term memory model sequentially processes the shell-formatted data and patterns of the production profiles.

4. The computer-implemented method of claim 2, wherein the sequential model comprises two fully connected layers and weights that are adjusted to determine the patterns of the production profiles, the weights being directly mappable to the spatial domain data.

5. The computer-implemented method of claim 2, wherein the bifurcated graph model splits the shell-formatted data into two parallel streams and applies convolution to one of the two parallel streams to determine the patterns of the production profiles.

6. The computer-implemented method of claim 1, wherein formatting the spatial domain data as shell-formatted data comprises:
performing data augmentation by generating synthetic data and adding the synthetic data to the spatial domain data to generate augmented data.

7. The computer-implemented method of claim 6, wherein performing the data augmentation comprises:
shifting a first portion of the spatial domain data and rotating a second portion of the spatial domain data.

8. The computer-implemented method of claim 1, wherein formatting the spatial domain data as shell-formatted data comprises:
applying standard linear interpolation to sample the spatial domain data for a set of spatial coordinates.

9. The computer-implemented method of claim 1, wherein formatting the spatial domain data as shell-formatted data comprises:
labeling the shell-formatted data to generate labeled shell formatting data.

10. The computer-implemented method of claim 1, wherein the rock properties comprise porosity, permeability, saturated hydrocarbon content, and clay content change.

11. The computer-implemented method of claim 1, further comprising:
generating a plot of the shell-formatted data that maps rock samples to areas of the plot, wherein points on the plot are plotted relative to an x-axis of effective porosity and a y-axis of total clay, and wherein a color or grayscale of a point is mapped to hydrocarbon volume scale; and
presenting the plot in a graphical user interface.

12. A computer-implemented system, comprising:
one or more data sources of petrophysical evaluation results that have been determined and collected for a tight hydrocarbon sandstone reservoir;
one or more graphical user interfaces (GUIs) for interacting with users and presenting information based on an analysis of the petrophysical evaluation results;
one or more processors; and
a non-transitory computer-readable storage medium coupled to the one or more processors and storing programming instructions for execution by the one or more processors, the programming instructions instructing the one or more processors to perform operations comprising:
receiving, from one or more probes, spatial domain data and temporal domain data, the spatial domain data characterizing rock properties within a subterranean volume comprising a hydrocarbon reservoir and the temporal domain data characterizing temporal variations of well productions;
formatting the spatial domain data as shell-formatted data comprising a shell format processable by prediction models, the shell format comprising a series of concentric shells within a spatial volume at different depths around a well bore;
providing the shell-formatted data as input for the prediction models to generate a plurality of well production profiles and hydrocarbon reservoir depletion profiles, the prediction models being trained using the temporal domain data; and
managing hydrocarbon production from the hydrocarbon reservoir based on the production profiles and the hydrocarbon reservoir depletion profiles.

13. The computer-implemented system of claim 12, wherein the prediction models comprise a bi-directional long short-term memory model, a sequential model, and a bifurcated graph model, wherein the bi-directional long short-term memory model sequentially processes the shell-formatted data and patterns of the production profiles, wherein the sequential model comprises two fully connected layers and weights that are adjusted to determine the patterns of the well production profiles, the weights being directly mappable to the spatial domain data.

14. The computer-implemented system of claim 13, wherein the bifurcated graph model splits the shell-formatted data into two parallel streams and applies convolution to one of the two parallel streams to determine patterns in the well production profiles.

15. The computer-implemented system of claim 12, wherein formatting the spatial domain data as shell-formatted data comprises:
performing data augmentation by generating synthetic data and adding the synthetic data to the spatial domain data to generate augmented data and by shifting a first portion of the spatial domain data and rotating a second portion of the spatial domain data.

16. The computer-implemented system of claim 12, wherein formatting the spatial domain data as shell-formatted data comprises:
applying standard linear interpolation to sample the spatial domain data for a set of spatial coordinates.

17. The computer-implemented system of claim 12, wherein formatting the spatial domain data as shell-formatted data comprises:
labeling the shell-formatted data to generate labeled shell formatting data.

18. The computer-implemented system of claim 12, wherein the rock properties comprise porosity, permeability, saturated hydrocarbon content, and clay content change.

19. The computer-implemented system of claim 12, wherein the operations further comprise:
generating a plot of the shell-formatted data that maps rock samples to areas of the plot, wherein points on the plot are plotted relative to an x-axis of effective porosity and a y-axis of total clay, and wherein a color or grayscale of a point is mapped to hydrocarbon volume scale; and
presenting the plot in a graphical user interface.

20. A non-transitory computer-readable media encoded with a computer program, the computer program comprising instructions that when executed by one or more computers cause the one or more computers to perform operations comprising:
receiving, from one or more probes, spatial domain data and temporal domain data, the spatial domain data characterizing rock properties within a subterranean volume comprising a hydrocarbon reservoir and the temporal domain data characterizing temporal variations of well productions;
formatting the spatial domain data as shell-formatted data comprising a shell format processable by prediction models, the shell format comprising a series of concentric shells within a spatial volume at different depths around a well bore;
providing the shell-formatted data as input for the prediction models to generate a plurality of well production profiles and hydrocarbon reservoir depletion profiles, the prediction models being trained using the temporal domain data; and
managing hydrocarbon production from the hydrocarbon reservoir based on the production profiles and the hydrocarbon reservoir depletion profiles.
